(19) United States
(12) Patent Application Publication
(10) Pub. No.: US 2024/0354874 A1
(43) Pub. Date: Oct. 24, 2024

(54) POWER TRANSACTION SYSTEM, POWER SUPPLY TRANSACTION MANAGEMENT METHOD, AND POWER DEMAND TRANSACTION MANAGEMENT METHOD

(71) Applicant: HITACHI, LTD., Tokyo (JP)

(72) Inventors: Toshiaki SUZUKI, Tokyo (JP); Yusuke SHOMURA, Tokyo (JP)

(21) Appl. No.: 18/683,796

(22) PCT Filed: Aug. 26, 2022
(86) PCT No.: PCT/JP2022/032266

§ 371 Date: Feb. 15, 2024

(30) Foreign Application Priority Data
Sep. 9, 2021 (JP) 2021-147157

(51) Int. Cl. G06Q 50/06; G06Q 10/04

(52) U.S. Cl. CPC G06Q 50/06; G06Q 10/04

(57) ABSTRACT

A power transaction system includes: a power supply system configured to manage a supply of the power; a power demand system configured to manage a demand of the power; and a power transaction management apparatus configured to manage demand and supply transactions. The power supply system registers a power supply plan having a plurality of conditions in the power transaction management apparatus, and the power demand system acquires the power supply plan from the power transaction management apparatus and selects the power supply system as a desired power supply source based on the acquired power supply plan, thereby establishing the demand and supply transactions.

### TECHNICAL FIELD

The present invention relates to a power transaction system, a power supply transaction management method, and a power demand transaction management method.

### BACKGROUND ART

In recent years, a use of electricity generated by renewable energy such as solar power and wind power increases in order to reduce CO2 emissions. In addition, many power transactions based on the renewable energy in a P2P (peer-to-peer) type are verified. In order to cope with an increase in power transactions between a power supplier and a power consumer in relation to the power based on the renewable energy, a system capable of performing power transactions considering a plurality of conditions is required.

As a background technique of this field, there is a technique described in PTL 1. The PTL 1 describes that “An object of the invention is to provide a system capable of virtually implementing sale and purchase of surplus power among consumers and enabling post-settlement for the sale and purchase of surplus power among consumers. As means for solving the problem, a surplus power transaction apparatus according to an embodiment includes a notification unit. The notification unit acquires a first electricity rate that is a rate per unit electricity amount purchased by a first consumer who desires to purchase the surplus power from a power company, and a second electricity rate that is a rate per unit electricity amount of surplus power sold by a second consumer who desires to sell the surplus power. Further, the notification unit notifies a terminal of the power company of consumer information associating the second consumer with the first consumer having the first electricity rate higher than the second electricity rate of the second consumer and the second electricity rate of the second consumer”.

Further, there is a technique described in PTL 2. The PTL 2 describes that “An object of the invention is to effectively use a power generation capability of a power supply source. In addition, as means for solving the problem, an energy virtual network operator (EVNO operator) 2 is connected to smart meters of a power generation source and a use source existing in a power transmission network, and when receiving a power use request from a point B, selects a point A as an optimum power generation source based on a distance to the point B, a property of the power generation source, and a supply capacity, and sends a power transmission request from the point A to the point B to a power company 1 managing the power transmission network. A billing processing unit 12 of a power company 1 determines an amount to be billed based on the distance between the point A and the point B, an electricity amount, and a time, and charges a billing processing unit 23 of the EVNO operator 2. An area broker that manages a power demand and supply state in an area is provided for each of areas obtained by dividing the power transmission network, and when a use source and a power generation source cross the area, a transaction is performed between the area brokers. In addition, when there are a plurality of EVNO operators in the same power transmission network, transactions are performed between the EVNO operators”.

Further, there is a technique described in PTL 3. The PTL 3 describes that “An object of the invention is to provide an energy electronic transaction system and an energy electronic transaction method that enable energy transactions in consideration of a plurality of factors related to energy demands. In addition, as means for solving the problem, a bid information determination unit 12 generates bid information 40. The bid information 40 includes a power constraint condition defined by a correlation between a power unit price and a carbon dioxide emission intensity. Each of bid information determining units TD1 to TDn generates bid information TJ based on the bid information 40 and supplier information PJ1 to PJn when the power constraint condition of the bid information 40 is satisfied. A winning bidder determining unit 13 determines a winning bidder including a predetermined number of supplier systems PS in a priority order based on the bid information TJ and consumer information 11 from the supplier systems PS1 to PSn. A winning bid information determining unit 14 determines an energy supply amount in consideration of the priority order for each winning bidder determined by the winning bidder determining unit 13”.

### CITATION LIST

### Patent Literature

PTL 1: JP2020-35353A
PTL 2: JP2011-223740A
PTL 3: JP2005-258880A

### SUMMARY OF INVENTION

### Technical Problem

However, the techniques described in the above PTL 1 and PTL 2 have a problem that the power consumer cannot autonomously select the power based on the renewable energy having characteristics such as a power generation type and a power generation position. Further, in the technique described in the above PTL 3, desired power demand specifications are notified to a large number of power suppliers in advance, and a supplier is selected from the plurality of specifications to which a response is made, resulting in an increase in a load on a communication network when there are many consumers and suppliers. There is a problem that a company providing a power transmission network corresponding to this technique cannot perform reduction control of the congestion degree of the transmission network.

The invention is made in view of the above-described problems, and an object thereof is to provide a power transaction system, a power supply transaction management method, and a power demand transaction management method, the power transaction system being capable of reducing a communication congestion degree in a power transaction and autonomously selecting a power supplier by a power consumer side.

### Solution to Problem

A power transaction system according to the invention is a power transaction system that performs demand and supply transactions of a power. The power transaction system includes: one or more power supply systems configured to manage supplies of the power; one or more power demand systems configured to manage demands of the power; and a power transaction management apparatus configured to manage demand and supply transactions of the power. The one or more power supply systems each register a power supply plan having a plurality of conditions in the power transaction management apparatus, and the power demand system acquires the power supply plan registered by each of the power supply systems from the power transaction management apparatus and selects the power supply system as a desired power supply source based on the acquired power supply plan, thereby establishing the demand and supply transactions.

A power supply transaction management method according to the invention includes: establishing a power supply transaction by a computer acquiring one or more power supply plans from a power transaction management apparatus, and selecting a power supply system as a desired power supply source based on a power demand position.

A power demand transaction management method according to the invention includes: establishing a power demand transaction by a computer acquiring one or more power demand plans from a power transaction management apparatus, and selecting a power demand system as a desired power demand destination based on a power supply position.

### Advantageous Effects of Invention

According to the invention, it is possible to provide a power transaction system, a power supply transaction management method, and a power demand transaction management method, the power transaction system being capable of reducing a communication congestion degree in a power transaction and autonomously selecting a power supplier by a power consumer side.

### BRIEF DESCRIPTION OF DRAWINGS

FIG. 1 is a functional block diagram showing a configuration of a power transaction system according to a first embodiment.

FIG. 2 is a table showing power network management data according to the first embodiment.

FIG. 3 shows a table showing power transmission price management data at a non-congestion time and a table showing power transmission price management data when congestion occurs according to the first embodiment.

FIG. 4 is a table showing power supply report management data according to the first embodiment.

FIG. 5 is a table showing power demand report management data according to the first embodiment.

FIG. 6A is a sequence diagram showing a power transaction when there is a power supply candidate according to the first embodiment.

FIG. 6B is a sequence diagram showing a power transaction when there is the power supply candidate according to the first embodiment.

FIG. 7 is a sequence diagram showing a power transaction when there is no power supply candidate according to the first embodiment.

FIG. 8 is a functional block diagram showing a configuration of a power transaction management apparatus according to the first embodiment.

FIG. 9 is a diagram showing an example of data stored in a memory in the power transaction management apparatus according to the first embodiment.

FIG. 10A is a flowchart showing a power transaction management procedure of the power transaction management apparatus according to the first embodiment.

FIG. 10B is a flowchart showing a power transaction management procedure of the power transaction management apparatus according to the first embodiment.

FIG. 10C is a flowchart showing a power transaction management procedure of the power transaction management apparatus according to the first embodiment.

FIG. 11 is a diagram showing an example of data stored in a memory in a power network management apparatus according to the first embodiment.

FIG. 12 is a flowchart showing a power network management procedure of the power network management apparatus according to the first embodiment.

FIG. 13 is a diagram showing an example of data stored in a memory in a power supply management apparatus according to the first embodiment.

FIG. 14A is a flowchart showing a power supply management procedure of the power supply management apparatus according to the first embodiment.

FIG. 14B is a flowchart showing a power supply management procedure of the power supply management apparatus according to the first embodiment.

FIG. 15 is a diagram showing an example of data stored in a memory in a power demand management apparatus according to the first embodiment.

FIG. 16A is a flowchart showing a power demand management procedure of the power demand management apparatus according to the first embodiment.

FIG. 16B is a flowchart showing a power demand management procedure of the power demand management apparatus according to the first embodiment.

FIG. 17 is a diagram showing a power supply selection screen according to the first embodiment.

FIG. 18 is a diagram showing a power demand selection screen according to the first embodiment.

FIG. 19 is a functional block diagram showing a configuration of a power transaction system according to a second embodiment.

FIG. 20A is a sequence diagram showing a power transaction when there is a power supply candidate according to the second embodiment.

FIG. 20B is a sequence diagram showing a power transaction when there is the power supply candidate according to the second embodiment.

### DESCRIPTION OF EMBODIMENTS

Hereinafter, embodiments according to the invention will be described with reference to the drawings. The following description and drawings are examples for showing the invention, and are appropriately omitted and simplified for clarity of the description. The invention can be implemented in various other forms. Unless otherwise specified, each element may be single or plural.

In order to facilitate understanding of the invention, the position, size, shape, range, and the like of each element shown in the drawings may not represent the actual position, size, shape, range, and the like. Therefore, the invention is not necessarily limited to the positions, sizes, shapes, ranges, and the like disclosed in the drawings.

### First Embodiment

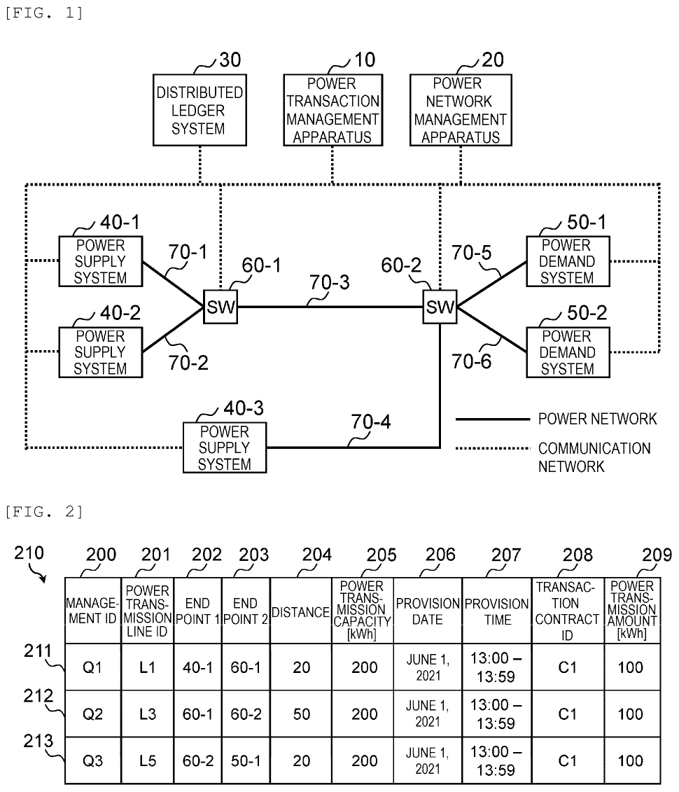

Hereinafter, a power transaction management operation according to a first embodiment of the invention will be described with reference to FIGS. 1 to 18. In the embodiment, a power transmission price is dynamically set in accordance with a state of a power network, and a power consumer side autonomously selects a power supplier to be transacted or contracted based on evaluation indices such as a power generation accuracy, a power rate, and a power transmission rate from a power supply plan (supply report list) from a power supplier and the power transmission price based on a demand position. Further, the power consumer side receives the power transmission price based on the power supply plan and the power demand position and selects a power supply source (supplier), and a power supplier side receives the power transmission price based on a power demand plan (demand report list) and the power supply position and selects a power demand destination (consumer).

FIG. 1 is a functional block diagram showing a configuration of a power transaction system according to the first embodiment.

As shown in FIG. 1, the power transaction system according to the embodiment includes a power transaction management apparatus 10 that manages power transactions, a power network management apparatus 20 that manages power networks, a distributed ledger system 30 that records power transactions, power supply systems 40-1 to 40-3 that supply power, power demand systems 50-1 and 50-2 that demand power, switches 60-1 and 60-2 that distribute power, a communication network for transmitting and receiving information among the apparatuses 10 and 20 and the systems 30, 40-1 to 40-3, 50-1, 50-2, 60-1, and 60-2, and power networks 70-1 to 70-6 for transmitting and receiving power among the systems 40-1 to 40-3, 50-1, 50-2, 60-1, and 60-2.

When the individual power supply systems are not distinguished from the power supply systems 40-1 to 40-3, the power supply systems are collectively referred to as a power supply system 40 in the following description. When the individual power demand systems are not distinguished from the power demand systems 50-1 and 50-2, the power demand systems are collectively referred to as a power demand system 50 in the following description. When the individual switches are not distinguished from the switches SW60-1 and 60-2, the switches are collectively referred to as a switch 60 in the following description.

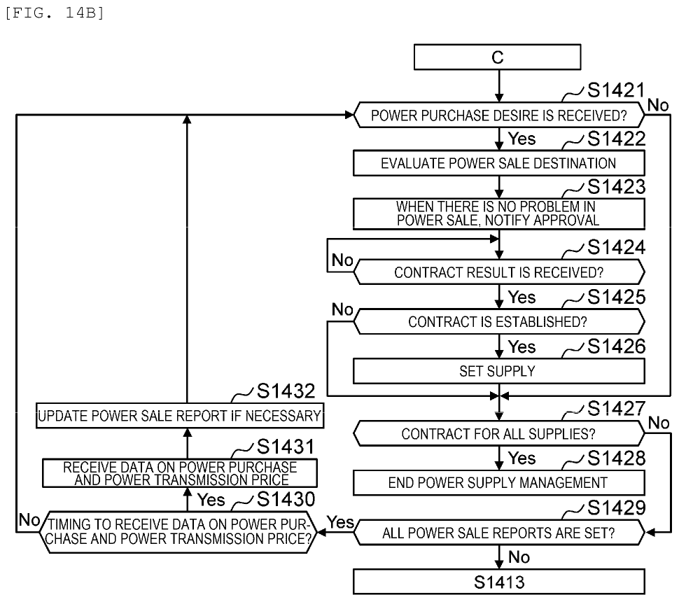

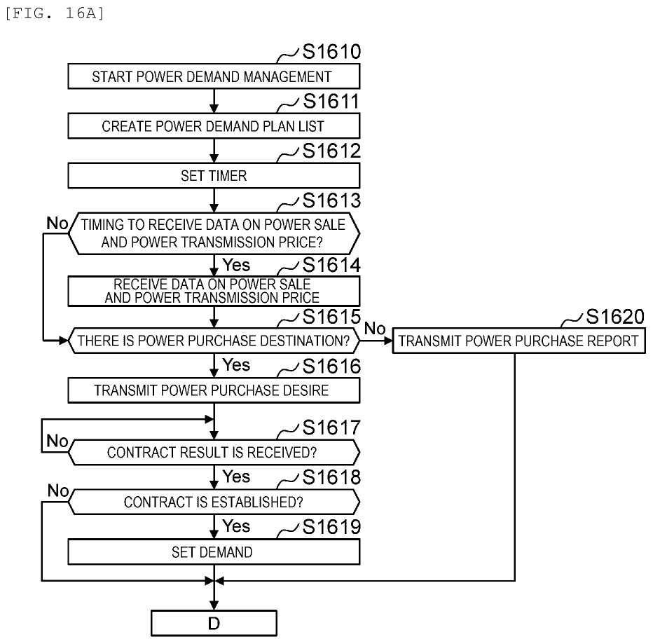

Although not shown in the drawings, the power supply systems 40-1 to 40-3 each include a power supply apparatus that can generate and measure power and a power supply management apparatus (described later with reference to FIGS. 8 and 13) that manages the supply of the power. Although not shown in the drawing, the power demand systems 50-1 and 50-2 each include a power demand apparatus that can consume and measure power and a power demand management apparatus (described later with reference to FIGS. 8 and 15) that manages power demands.

In addition, although not shown in the drawings, the distributed ledger system 30 includes a plurality of nodes for data recording, and each node records and holds power transaction data having the same content. The distributed ledger system 30 is configured using, for example, a blockchain technique.

When a report of a power demand is registered in the power transaction management apparatus 10, the power supply system 40 selects the power demand system 50 having a desired power demand destination (consumer) from the report. On the other hand, when the report of the power demand from the power consumer is not registered in the power transaction management apparatus 10 or when an appropriate demand destination (consumer) is not registered, the power supply system 40 registers a power supply plan having a plurality of conditions in the power transaction management apparatus 10.

When the report of the power supply plan is registered in the power transaction management apparatus 10, the power demand system 50 receives the report of the power supply plan and a power transmission rate list from the power transaction management apparatus 10, and selects the power supplier as a power purchase desire destination based on the power demand position, a power supply price, the power generation accuracy, the power transmission rate, and the like. On the other hand, when the report of the power supply plan from the power supplier is not registered in the power transaction management apparatus 10, or when a power supply source (power supplier) satisfying a condition desired by the power consumer is not registered, the power demand system 50 registers the report of the power demand plan in the power transaction management apparatus 10.

When there is a power supplier satisfying a desired condition, the power demand system 50 notifies the power supply system 40 of a purchase contract desire for the power supplier via the power transaction management apparatus 10. The power supply system 40 evaluates an acquired power purchase desire request from the power demand system 50, and notifies the power demand system 50, which has requested the power purchase contract, of an availability of a power sale via the power transaction management apparatus 10.

The power network management apparatus 20 evaluates a state (congestion degree) of the power network at predetermined time intervals, dynamically sets the power transmission price, and notifies the power transaction management apparatus 10 of the power transmission price. The congestion degree of the power network is a utilization rate for an allowable power transmission amount on a power line, and for example, it is determined that the power transmission line is congested when the utilization rate is 50% or more. In addition, the power network management apparatus 20 determines the state of the power network to determine whether power can be transmitted, and responds to an inquiry about whether the power can be transmitted from the power transaction management apparatus 10.

The power transaction management apparatus 10 receives and registers power transmission price data from the power network management apparatus 20, the report of the power supply plan from the power supply system 40, and the report of the power demand plan from the power demand system 50. In addition, when report data of the power demand plan from the power supply system 40 and the power transmission price data are e requested, the power transaction management apparatus 10 provides the report data of the power demand plan from the power supply system 40 and the power transmission price data. Similarly, when report data of the power supply plan from the power demand system 50 and the power transmission price data are requested, the power transaction management apparatus 10 provides the report data of the power supply plan from the power demand system 50 and the power transmission price data.

The power transaction management apparatus 10 confirms with the power network management apparatus 20 whether power as a power transaction candidate can be transmitted based on a request from the power supply system 40 or the power demand system 50. In addition, when it is confirmed that there is no problem in power transmission from the power network management apparatus 20, the power transaction management apparatus 10 establishes a contract of the corresponding power transaction and records the established contract in the distributed ledger system 30.

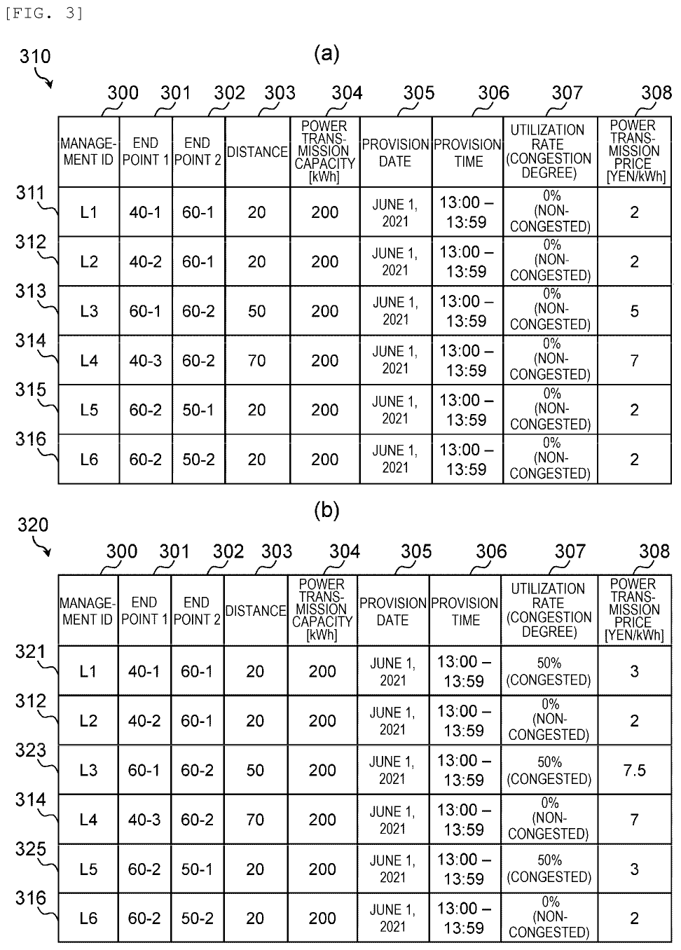

FIG. 2 is a table showing power network management data according to the first embodiment.

The power network management data 210 includes fields of a management ID (identifier) 200 of a power transmission contract, an ID 201 for identifying each power transmission line, identifiers of a first end point 202 and a second end point 203 with respect to the power transmission line, a distance 204 of the power transmission line (for example, the power network 70-1) between the first end point 202 and the second end point 203, a power transmission capacity 205 per hour, a provision date 206 and a provision time 207 on which power transmission is executed, a transaction contract ID 208 of a power transaction for providing power transmission, and a scheduled power transmission amount 209.

The power network management data indicated in a row 211 indicates that a management ID is Q1, an ID of the power transmission line is L1, end points of the power transmission line are 40-1 (power supply system) and 60-1 (switch SW), a power transmission distance between the two end points is 20 km, a power transmission capacity is 200 kWh, an execution date of the power transmission is Jun. 1, 2021, an execution time is 13:00 to 13:59, a contract ID of the power transaction for providing the power transmission is C1, and a scheduled power transmission amount is 100 kWh. In addition, Q2 (row 212) and Q3 (row 213), which are different management IDs, have the same configuration contents. Accordingly, a state of a power transmission region in a power network is known, and a power transmission price list for each power transmission region to be described later can be created based on the state.

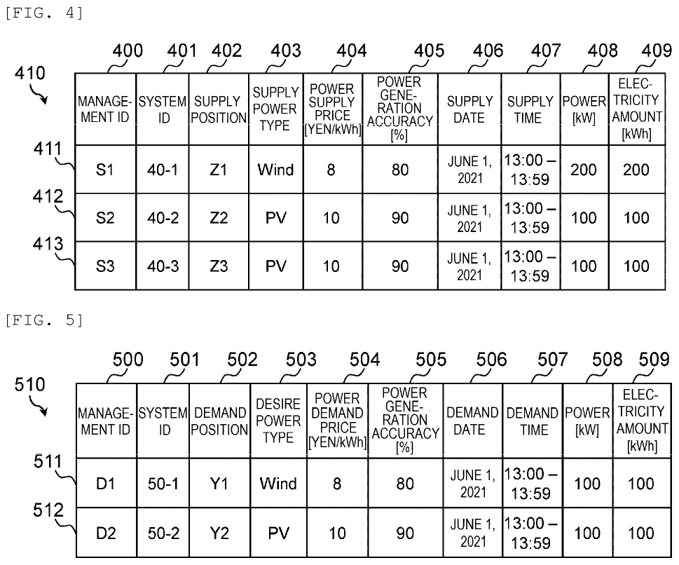

(a) of FIG. 3 is a table showing power transmission price management data at a non-congestion time according to the first embodiment. The power transmission price management data 310 is a power transmission price list including fields of a management ID 300 for identifying a power transmission line, identifiers of a first end point 301 and a second end point 302 with respect to the power transmission line, a distance 303 of the power transmission line between the first end point 301 and the second end point 302, a power transmission capacity 304 per hour, a provision date 305 and a time 306 on which power transmission is executed, a utilization rate (congestion degree) 307 with respect to the power transmission capacity, and a power transmission price 308.

The power transmission price management data indicated in a row 311 indicates that a management ID of the power transmission line is L1, end points of the power transmission line are 40-1 and 60-1, a power transmission distance between the two end points is 20 km, a power transmission capacity is 200 kWh, an execution date of the power transmission is Jun. 1, 2021, an execution time is 13:00 to 13:59, a power transmission utilization rate (congestion degree) is 0%, and a power transmission price is 2 yen/kWh. In addition, L2 to L6 (row 312 to row 316), which are different management IDs, have the same configuration contents. The power transmission utilization rate (congestion degree) 307 and the power transmission price 308 are dynamically changed at any time.

(b) of FIG. 3 is a table showing power transmission price management data when congestion occurs according to the first embodiment.

The power transmission price management data 320 has the same configuration as the power transmission price management data 310, but has contents at a congestion time (there is a utilization: rate of 50%). The power transmission price management data indicated in the row 321 indicates that the management ID of the power transmission line is L1, the end points of the power transmission line are 40-1 and 60-1, the power transmission distance between the two end points is 20 km, the power transmission capacity is 200 kWh, the execution date of power transmission is Jun. 1, 2021, the execution time is 13:00 to 13:59, a power transmission utilization rate (congestion degree) is 50%, and a power transmission price is 3 yen/kWh.

Here, in the power transmission line L1 (row 321), power transmission for 100 kWh is already scheduled for the power transmission capacity of 200 kWh, and the utilization rate (congestion degree) is 50%. As a result, it is found that the power transmission line L1 is determined to be in a congestion state, and the power transmission price is increased from 2 yen/kWh to 3 yen/kWh. In addition, in the power transmission price management data shown in a row 323 and a row 325, power transmission lines are determined to be in the congestion state at the utilization rate of 50% as in the row 321. On the other hand, in the row 312, the row 314, and the row 316, power transmission lines are determined to be in a non-congested state at the utilization rate of 0%, and have the same contents as those in (a) of FIG. 3.

As described above, the power transmission price list shown in (a) and (b) of FIG. 3 is a part of the power transmission price which is determined regardless of a power supply price of the power supply plan proposed by the power supplier to the power consumer, the power transmission price changes depending on a power transmission distance and the congestion degree, and the utilization rate and a part of the power transmission price are dynamically changed at any time.

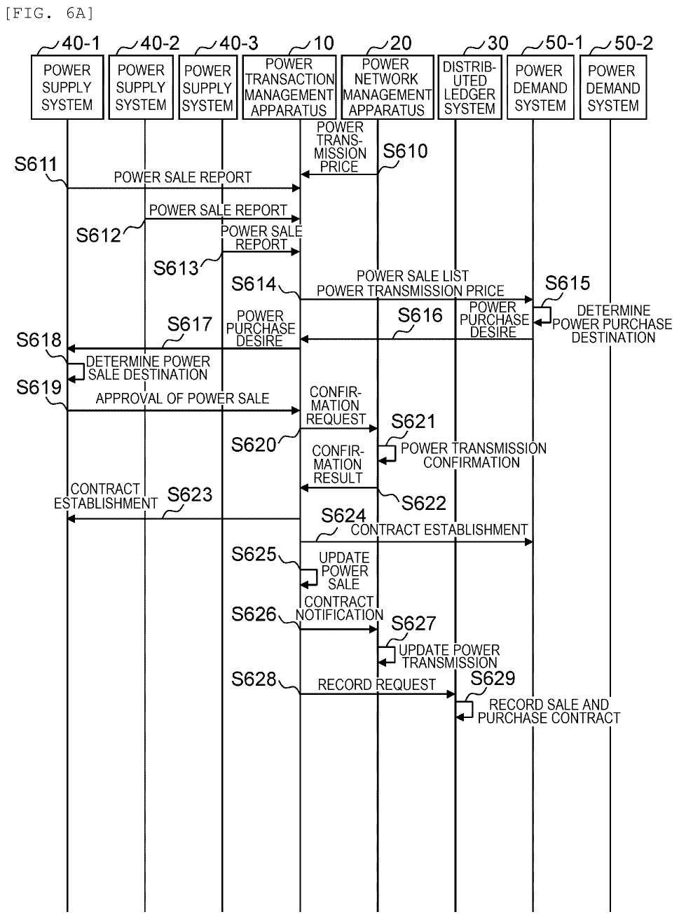

FIG. 4 is a table showing power supply report management data according to the first embodiment.

Power supply report data 410 is a power sale list to a consumer including fields of a management ID 400 for identifying a power supply report, a system ID 401 for identifying a reported system, a power supply position 402, a supply power type 403, a desired power supply price 404, a power generation accuracy 405 indicating a possibility of power generation, a power supply date 406 and a time 407, and a power 408 and an electricity amount 409 that can be supplied.

The power supply report data 410 shown in a row 411 presented from a certain power supplier indicates that a management ID is S1, a system ID is 40-1, a supply position is Z1, a supply power type is Wind (wind power generation), a desired power supply price is 8 yen/kWh, a power generation accuracy is 80%, a supply date is Jun. 1, 2021, a supply time is 13:00 to 13:59, a power and an electricity amount that can be supplied are 200 kW and 200 kWh. In addition, power supply report data of rows 412 and 413 presented from other power suppliers also has the same configuration content as that of the row 411.

The power supply report data 410 is a power supply plan having a plurality of conditions provided by the power suppliers having the respective power supply systems 40-1 to 40-3, and the power supply report data 410 is registered in the power transaction management apparatus 10 (see FIG. 1), so that power consumers having the power demand systems 50-1 and 50-2 can select a desired power supplier.

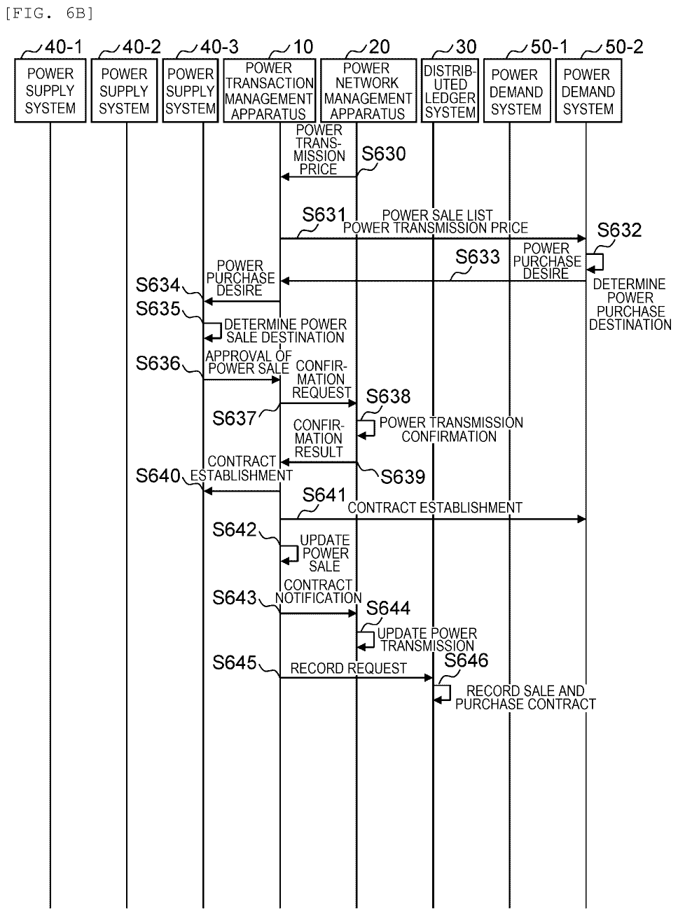

FIG. 5 is a table showing power demand report management data according to the first embodiment.

Power demand report data 510 is a power purchase list including fields of a management ID 500 for identifying a power demand report, a system ID 501 for identifying a reported system, a power demand position 502, a desired demand power type 503, a desired power demand price 504, a power generation accuracy 505 indicating a possibility of desired power generation, a power demand date 506 and a time 507, and a power 508 and an electricity amount 509 of a demand schedule.

The power demand report data shown in a row 511 presented from a certain power consumer indicates that a management ID is D1, a system ID is 50-1, a demand position is Y1, a demand power type is Wind (wind power generation), a desired power demand price is 8 yen/kWh, a power generation accuracy is 80%, a demand date is Jun. 1, 2021, a demand time is 13:00 to 13:59, a power and an electricity amount of a demand schedule are 100 kW and 100 kWh. In addition, power demand report data of a row 512 presented from another power consumer also has the same configuration content as that of the row 511.

The power demand report data 510 is a power demand plan having a plurality of conditions provided by the power consumers having the respective power demand systems 50-1 and 50-2, and the power demand report data 510 is registered in the power transaction management apparatus 10 (see FIG. 1), so that the power suppliers having the respective power supply systems 40-1 to 40-3 can select a desired power consumer.

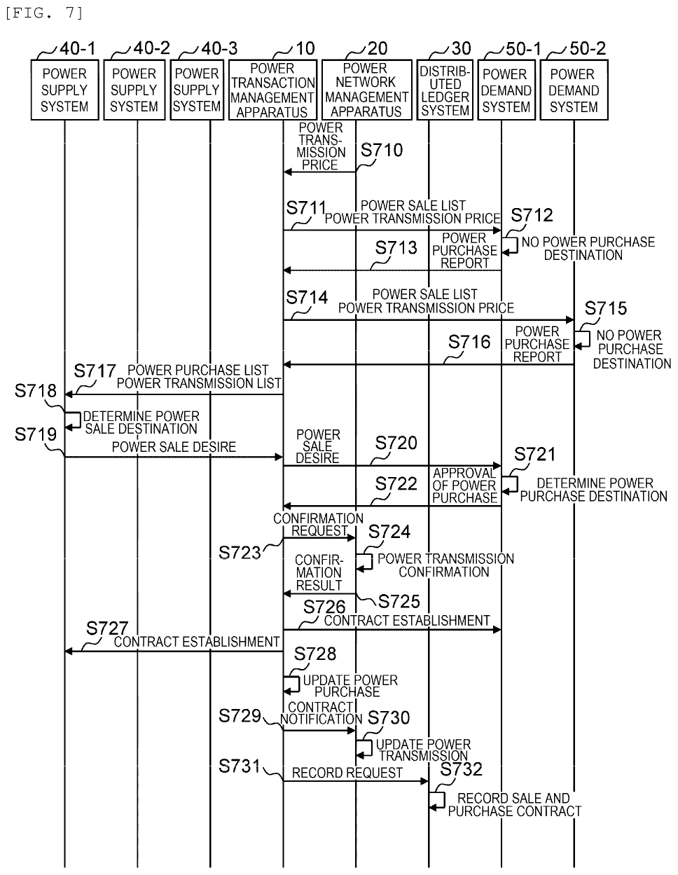

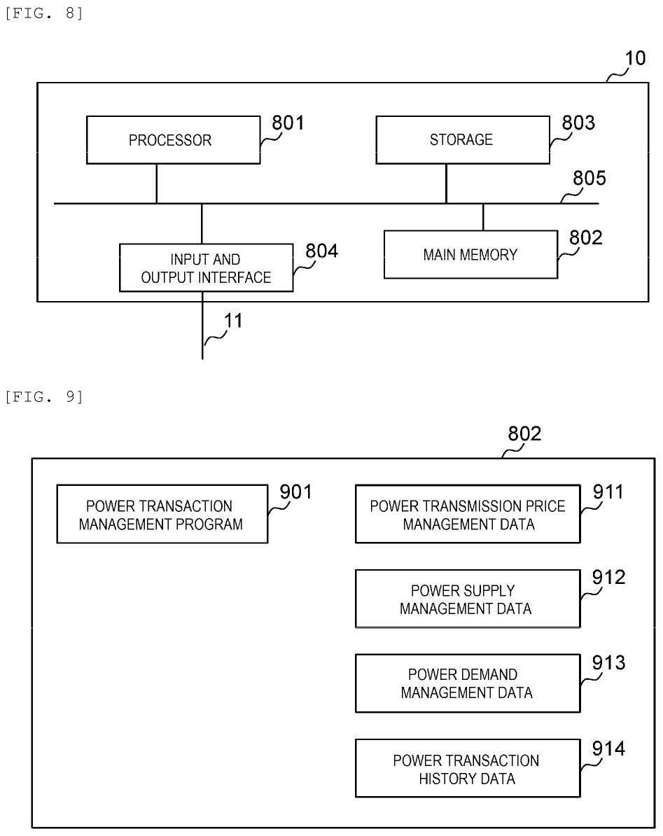

FIGS. 6A and 6B are sequence diagrams showing a power transaction when there is a power supply candidate according to the first embodiment.

First, as preparation for a power transaction, the power network management apparatus 20 evaluates a state of a power network based on the power network management data (no data at an initial stage) shown in FIG. 2, creates the power transmission price management data (for example, (a) of FIG. 3), and notifies the power transaction management apparatus 10 (step S610).

The power supply system 40-1 notifies the power transaction management apparatus 10 of a power sale report of a power assumed to be supplied (for example, data: 401 to 409 excluding the management ID in the row 411 of FIG. 4) (step S611).

Similarly, the power supply system 40-2 notifies the power transaction management apparatus 10 of a power sale report of a power assumed to be supplied (for example, data: 401 to 409 excluding the management ID in the row 412 of FIG. 4) (step S612).

Similarly, the power supply system 40-3 notifies the power transaction management apparatus 10 of a power sale report of a power assumed to be supplied (for example, data: 401 to 409 excluding the management ID in the row 413 of FIG. 4) (step S613).

As shown in steps S611 to S613, first of all, a power sale list including specific conditions of the power supply plan from each power supplier is presented to a transaction market of the power transaction management apparatus 10. Characteristics, prices, and the like of this power sale list are confirmed, and the power consumer side proceeds to study a power purchase destination (supplier).

The power transaction management apparatus 10 notifies the power demand system 50-1 of the power sale list (for example, data in FIG. 4) and the power transmission price data (for example, data in (a) of FIG. 3) based on a request from the power demand system 50-1 (step S614).

The power demand system 50-1 stores and holds the received power sale list and the power transmission price data, and determines a power supplier as the power purchase destination (step S615). In addition, the power demand system 50-1 notifies the power transaction management apparatus 10 of the power purchase destination (for example, the management ID data: S1 shown in the row 411 of FIG. 4) which is the power supplier satisfying a power purchase desire and a power demand specification (for example, the data: 501 to 509 excluding the management ID in the row 511 of FIG. 5) (step S616).

The power transaction management apparatus 10 notifies the power supply system 40-1, which is the consumer designated as the desired power purchase destination, of the received power demand specification (step S617).

The power supply system 40-1 determines whether a power can be supplied with respect to the received power demand specification (step S618). In addition, when the power supply system 40-1 determines that the power can be supplied in a system of the power supplier, the power supply system 40-1 notifies the power transaction management apparatus 10 of approval of a power sale (step S619). When there is a problem in the power sale, the power supply system 40-1 notifies the power transaction management apparatus 10 that the power cannot be supplied.

When the power transaction management apparatus 10 receives the approval of the power sale from the power supply system 40-1, the power transaction management apparatus 10 notifies the power network management apparatus 20 of a confirmation request in order to confirm whether the corresponding power can be transmitted in a power transmission network of a target section (step S620).

The power network management apparatus 20 determines whether there is a problem in power transmission as the power transmission capacity based on the held power network management data (step S621), and replies a confirmation result of power transmission permission to the power transaction management apparatus 10 when there is no problem (step S622). When there is a problem in the power transmission, the power network management apparatus 20 replies a message indicating power transmission being impossible to the power transaction management apparatus 10.

When the power transaction management apparatus 10 receives the power transmission permission from the power network management apparatus 20, the power transaction management apparatus 10 notifies the power supply system 40-1 of contract establishment (the power price and a half price of the power transmission price that is split to a half from the power supplier and the power consumer) (step S623). The power transaction management apparatus 10 notifies the power demand system 50-1 of the contract establishment (step S624). The power transmission price is half at a power supply side and a power demand side, but may be another ratio, and for example, the power transmission price may be 100% burden on the power demand side.

The power transaction management apparatus 10 updates the power supply report data in FIG. 4 in relation to the contract-established power supply (step S625).

Specifically, with respect to the electricity amount 409 in the row 411 of FIG. 4, the electricity amount that can be supplied is decreased from 200 kWh to 100 kWh and updated. In addition, the power transaction management apparatus 10 notifies the power network management apparatus 20 of established contract (transmission and reception of power) information (step S626).

Upon receiving the established contract information, the power network management apparatus 20 updates the power network management data shown in FIG. 2 (step S627). Since there is no setting in the power transmission at the initial stage, the power network management data shown in FIG. 2 is in a state with no description, and thus the power network management data shown in FIG. 2 includes the contract of the transmission and reception of the power received this time.

The power transaction management apparatus 10 notifies the distributed ledger system 30 of a recording request of the established power transaction information (step S628).

The distributed ledger system 30 records the received power transaction information (step S629).

Subsequently, in order to prepare for a second power transaction, as shown in (b) of FIG. 6, the power network management apparatus 20 evaluates the state of the power network based on the power network management data shown in FIG. 2 after a predetermined time elapses, creates the power transmission price management data (for example, (b) of FIG. 3), and notifies the power transaction management apparatus 10 (step S630).

The power transaction management apparatus 10 notifies the power demand system 50-2 of the power sale list (for example, the data in FIG. 4, however, the electricity amount that can be supplied in the row 411 is 100 kWh) and the power transmission price data (for example, data in (b) of FIG. 3) based on a request from the power demand system 50-2 (step S631).

The power demand system 50-2 stores and holds the received power sale list and the power transmission price data, and determines a power supplier as the power purchase destination (step S632). In addition, the power demand system 50-2 notifies the power transaction management apparatus 10 of the determined power purchase destination (for example, the management ID data: S3 shown in the row 413 of FIG. 4) of a power as a power purchase desire and a power demand specification (for example, the data: 501 to 509 excluding the management ID in the row 512 of FIG. 5) (step S633).

In this manner, with respect to a power demand of contents shown in the row 512 of FIG. 5, a power supply source satisfying this specification can be reflected in the power sale list of FIG. 4, but there are cases where power transmission prices vary depending on the congestion state of the power transmission lines, a power transmission distance, or the like. Therefore, the price of the power to be used and the price of the power to be transmitted are combined as a total fee, and the conditions of the respective management IDs are compared with each other, so that it is possible to select a power sale destination capable of using the power at a low price.

The power transaction management apparatus 10 notifies the power supply system 40-3 designated as the power purchase destination of the received power demand specification (step S634).

The power supply system 40-3 determines whether a power can be supplied with respect to the received power demand specification (step S635). In addition, when the power supply system 40-3 determines that the power can be supplied, the power supply system 40-3 notifies the power transaction management apparatus 10 of approval of a power sale with respect to a target power consumer (step S636). When there is a problem in the power sale, the power supply system 40-3 notifies the power transaction management apparatus 10 that the power cannot be supplied.

When the power transaction management apparatus 10 receives the approval of the power sale, the power transaction management apparatus 10 notifies the power network management apparatus 20 of a confirmation request in order to confirm whether the corresponding power can be transmitted (step S637).

The power network management apparatus 20 determines whether there is a problem in power transmission as the power transmission capacity based on the held power network management data (step S638), and replies a confirmation result of power transmission permission to the power transaction management apparatus 10 when there is no problem (step S639). When there is a problem in the power transmission, the power network management apparatus 20 replies a message indicating power transmission being impossible to the power transaction management apparatus 10.

When the power transaction management apparatus 10 receives the power transmission permission, the power transaction management apparatus 10 notifies the power supply system 40-3 of the contract establishment (step S640). The power transaction management apparatus 10 notifies the power demand system 50-2 of the contract establishment (step S641).

The power transaction management apparatus 10 updates the power supply report data in FIG. 4 in relation to the contract-established power supply (step S642). Specifically, with respect to the electricity amount 409 in the row 413 of FIG. 4, the electricity amount that can be supplied is decreased from 100 kWh to 0 kWh and updated (the power supply report in the row 413 is deleted). In addition, the power transaction management apparatus 10 notifies the power network management apparatus 20 of established contract (transmission and reception of power) information (step S643).

Upon receiving the established contract information, the power network management apparatus 20 updates the power network management data shown in FIG. 2 (step S644).

The power transaction management apparatus 10 notifies the distributed ledger system 30 of a recording request of the established power transaction information (step S645).

The distributed ledger system 30 records the received power transaction information (step S646).

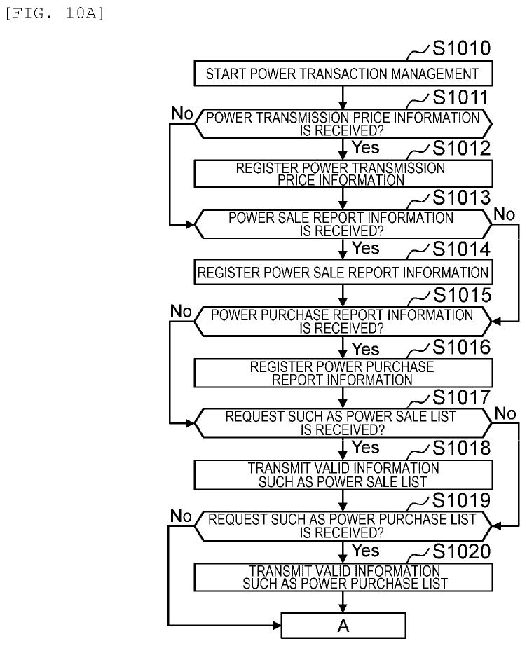

FIG. 7 is a sequence diagram showing a power transaction when there is no power supply candidate according to the first embodiment.

As preparation for a power transaction, the power network management apparatus 20 evaluates a state of a power network based on the power network management data (no data at an initial stage) shown in FIG. 2, creates the power transmission price management data (for example, FIG. 3A), and notifies the power transaction management apparatus 10 (step S710).

The power transaction management apparatus 10 notifies the power demand system 50-1 of the power sale list (for example, the data configuration of FIG. 4, but there is no data at an initial stage) and the power transmission price data (for example, data in (a) of FIG. 3) based on a request from the power demand system 50-1 (step S711).

The power demand system 50-1 stores and holds the received power sale list and power transmission price data and selects a power supplier as the power purchase destination, and determines that there is no power supplier as the power purchase destination when there is no data in the power sale list or there is no power sale data as the power supply plan satisfying a desire of the power consumer even if there is the power sale list (step S712). In this case, the power demand system 50-1 notifies the power transaction management apparatus 10 of a report of the power sale (step S713). For example, in the data shown in the row 511 of FIG. 5, the power demand system 50-1 notifies the power transaction management apparatus 10 of the power demand plans of the data 501 to 509 excluding the management ID 500 as the power purchase list.

The power transaction management apparatus 10 notifies the power demand system 50-2 of the power sale list (for example, the data configuration of FIG. 4, but there is no data at an initial stage) and the power transmission price data (for example, data in (a) of FIG. 3) based on a request from the power demand system 50-2 which is a consumer different from the power consumer including the power demand system 50-1 (step S714).

The power demand system 50-2 stores and holds the received power sale list and the power transmission price data and selects a power supplier as a power purchase destination of a power, and determines that there is no power purchase destination when there is no data in the power sale list or there is no power sale data satisfying a desire of the power demand system 50-2 (step S715). In this case, the power demand system 50-2 notifies the power transaction management apparatus 10 of a report of the power sale (step S716). For example, in the data shown in the row 512 of FIG. 5, the power demand system 50-2 notifies the power transaction management apparatus 10 of the report of the power sale of the data 501 to 509 excluding the management ID 500.

The power transaction management apparatus 10 notifies the power supply system 40-1 of the power purchase list (for example, data in FIG. 5) and the power transmission price data (for example, data in (a) of FIG. 3) based on a request from the power supply system 40-1 (step S717).

The power supply system 40-1 stores and holds the received list of power purchase list as the power demand plan and the power transmission price data, and determines a power sale destination of a power (step S718). In addition, the power supply system 40-1 notifies the power transaction management apparatus 10 of the determined power consumer as the power sale destination (for example, the management ID data: D1 shown in the row 511 of FIG. 5) of the power as a power sale desire and a power demand specification (for example, the data: 401 to 409 excluding the management ID in the row 411 of FIG. 4) (step S719). Here, it is assumed that the above-described demand specification is the power supply of the contents shown in the row 411 of FIG. 4, but the row 511 shown in FIG. 5 is conceivable as the power demand destination satisfying this specification. Therefore, the power supply system 40-1 selects the power demand shown in the row 511 of FIG. 5 as the power sale destination of the power.

The power transaction management apparatus 10 notifies the power demand system 50-1 designated as the power sale destination of the received power demand specification (step S720).

The power demand system 50-1 determines whether a power can be demanded with respect to the received power demand specification (step S721). In addition, when the power demand system 50-1 determines that the power can be demanded, the power demand system 50-1 notifies the power transaction management apparatus 10 of approval of a power purchase (step S722). When there is a problem in the power purchase, the power demand system 50-1 notifies the power transaction management apparatus 10 that the power cannot be demanded.

When the power transaction management apparatus 10 receives the approval of the power purchase, the power transaction management apparatus 10 notifies the power network management apparatus 20 of a confirmation request in order to confirm whether the corresponding power can be transmitted (step S723).

The power network management apparatus 20 determines whether there is a problem in power transmission as the power transmission capacity based on the held power network management data (step S724), and replies a confirmation result of power transmission permission to the power transaction management apparatus 10 when there is no problem (step S725). When there is a problem in the power transmission, the power network management apparatus 20 replies a message indicating power transmission being impossible to the power transaction management apparatus 10.

When the power transaction management apparatus 10 receives the power transmission permission, the power transaction management apparatus 10 notifies the power demand system 50-1 of the contract establishment (half price of the power transmission price and power price) (step S726). In addition, the power transaction management apparatus 10 notifies the power supply system 40-1 of the contract establishment (half price of the power transmission price and power price) (step S727).

The power transaction management apparatus 10 updates the power demand report data in FIG. 5 in relation to the contract-established power demand (step S728). Specifically, with respect to the electricity amount 509 in the row 511 of FIG. 5, the electricity amount that can be demanded is updated to 0 kWh (the power demand report in the row 511 is deleted). In addition, the power transaction management apparatus 10 notifies the power network management apparatus 20 of established contract (transmission and reception of power) information (step S729).

Upon receiving the established contract information, the power network management apparatus 20 updates the power network management data shown in FIG. 2 (step S730). Actually, since there is no setting in the power transmission at the initial stage, the power network management data shown in FIG. 2 is in the state with no description. The power network management data shown in FIG. 2 includes the contract of the transmission and reception of the power received this time.

The power transaction management apparatus 10 notifies the distributed ledger system 30 of a recording request of the established power transaction information (step S731).

The distributed ledger system 30 records the received power transaction information (step S732).

FIG. 8 is a functional block diagram showing a configuration of the power transaction management apparatus 10 according to the first embodiment. The power transaction management apparatus 10 includes a CPU 801 as a processor (processing device), a main memory 802 as a storage device, a storage 803, and an input and output interface 804 that transmits and receives data to and from the communication network 11, and the components are connected to one another via a bus 805. The power transaction management apparatus 10 may further include an input and output device (not shown), for example, a keyboard or an image display device.

The CPU (processor) 801 controls each unit of the power transaction management apparatus 10, loads a program stored in the storage 803 into the main memory 802, and executes the program to execute each functional unit in the power transaction management apparatus 10. The main memory 802 stores a power transaction management program executed by the CPU 801 and work data (power transmission price management data, power supply management data, power demand management data, and power transaction history data) necessary for executing the program. The storage 803 is a large-capacity storage device such as a Solid-State Drive (SSD) or a Hard Disk Drive (HDD). Some or all of the programs and pieces of data may be stored in the storage 803 in advance, or a program stored in an external storage may be stored in the storage 803 via the network 11 or a portable storage medium. Each storage and the storage medium are nonvolatile (or non-transitory). The power network management apparatus, the power supply management apparatus, and the power demand management apparatus have the same configuration as described above.

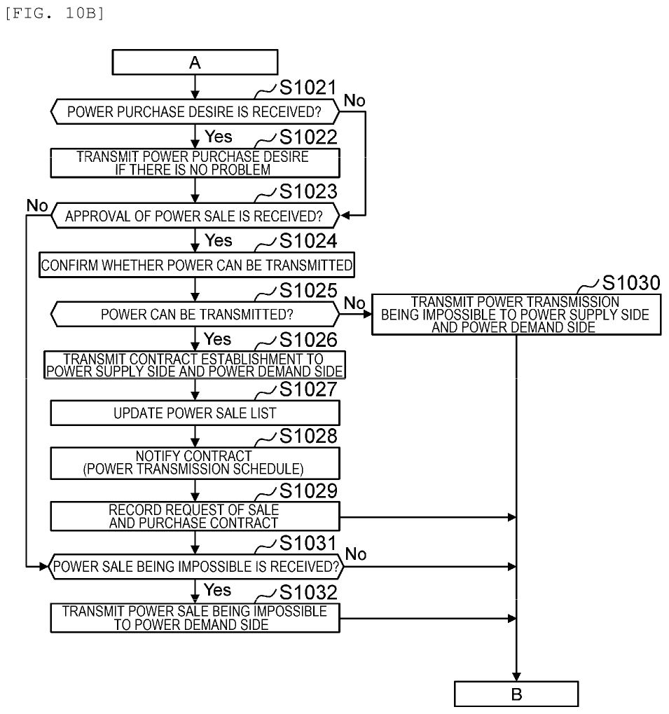

FIG. 9 is a diagram showing an example of data stored in a memory in the power transaction management apparatus 10 according to the first embodiment.

A power transaction management program 901 is loaded into the main memory 802 and executed. In addition, power transmission price management data 911, power supply management data 912, power demand management data 913, and power transaction history data 914 necessary for executing the program are held.

The power transmission price management data 911 is data shown in (a) and (b) of FIG. 3, and includes the power transmission price, the utilization rate (congestion degree) data, and the like. The power supply management data 912 is data shown in FIG. 4, and is list data of a reported power supply schedule. The power demand management data 913 is data shown in FIG. 5, and is list data of a reported power demand schedule. The power transaction history data 914 is history data of power transactions established between the power supply system 40 and the power demand system 50.

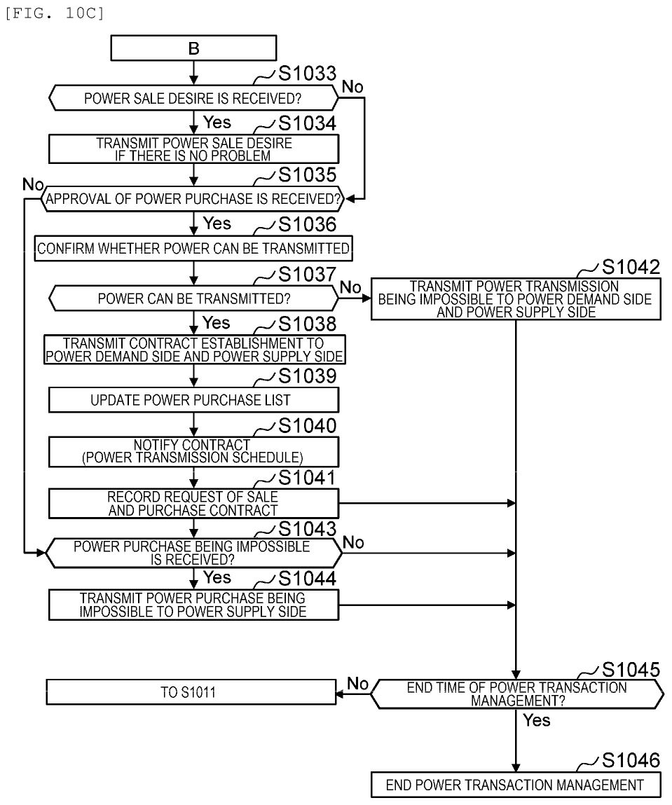

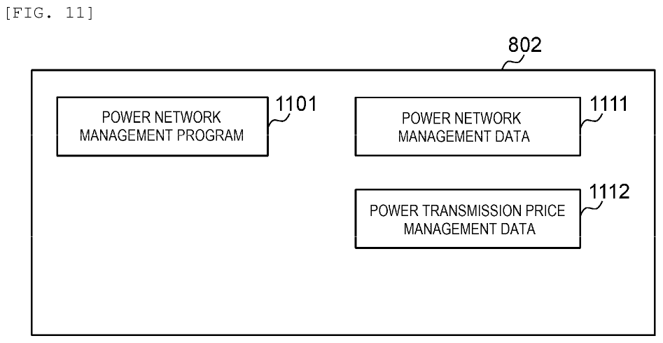

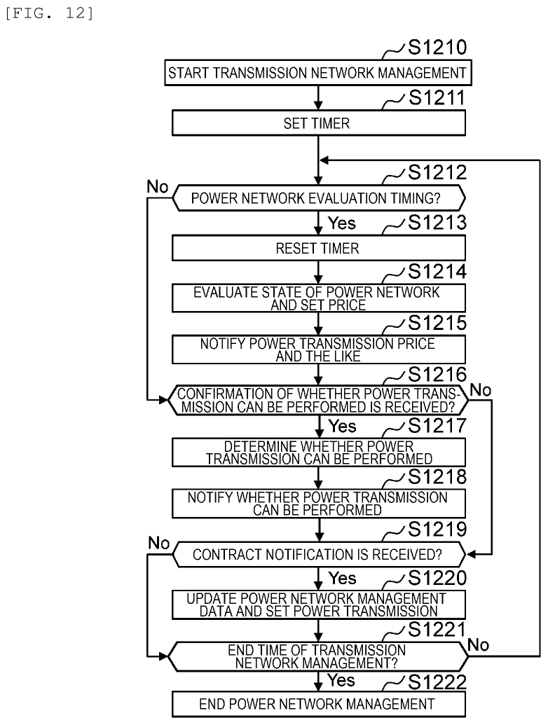

FIGS. 10A to 10C are a flowchart showing a power transaction management procedure of the power transaction management apparatus 10 according to the first embodiment.

The flowchart will be described below. The CPU 801 of the power transaction management apparatus 10 loads the power transaction management program 901 stored in the storage 803 into the main memory 802, and starts power transaction management (step S1010).

The power transaction management apparatus 10 determines whether the power transmission price information is received from the power network management apparatus 20 (step S1011).

When it is determined in the determination of step S1011 that the power transmission price is received, the data is registered (stored and held) (step S1012).

When it is determined in the determination of step S1011 that the power transmission price is not received, or when step S1012 is executed, the power transaction management apparatus 10 determines whether power sale report information (schedule information of the power supply plan) is received (step S1013).

When it is determined in the determination of step S1013 that the power sale report information is received, the data is registered (stored and held) (step S1014).

When it is determined in the determination of step S1013 that the power sale report information is not received, or when step S1014 is executed, the power transaction management apparatus 10 determines whether power purchase report information (schedule information of the power demand plan) is received (step S1015).

When it is determined in the determination of step S1015 that the power purchase report information is received, the data is registered (stored and held) (step S1016).

When it is determined in the determination of step S1015 that the power purchase report information is not received, or when step S1016 is executed, the power transaction management apparatus 10 determines whether a provision request of a power sale report information list (power supply management data) and the power transmission price management data is received (step S1017).

When it is determined in the determination of step S1017 that the provision request of the power sale report information list or the like is received, the power sale report information list (power supply management data) and the power transmission price management data which are currently valid are provided to the power demand system 50 which makes the request (step S1018).

When it is determined in the determination of step S1017 that the provision request of the power sale report information list or the like is not received, or when step S1018 is executed, the power transaction management apparatus 10 then determines whether a provision request of a power purchase report information list (power demand management data) and the power transmission price management data is received (step S1019).

In the determination of step S1019, when it is determined that the provision request of the power purchase report information list or the like is received, the power purchase report information list (power demand management data) and the power transmission price management data which are currently valid are provided to the power supply system 40 which makes the request (step S1020).

When it is determined in the determination of step S1019 that the provision request of the power purchase report information list or the like is not received, or when step S1020 is executed, the power transaction management apparatus 10 then determines whether a power purchase desire (power demand desire) is received (FIG. 10B, step S1021).

When it is determined in the determination of step S1021 that the power purchase desire (power demand desire) is received, and there is a corresponding power supply schedule, the designated power supply system 40 is notified (step S1022). In addition, when there is no corresponding power supply schedule, a reply indicating that the desire cannot be accepted is sent to the power demand system 50 that transmits the power purchase desire.

When it is determined in the determination of step S1021 that the power purchase desire is not received, or when step S1022 is executed, the power transaction management apparatus 10 then determines whether approval of a power sale from the power supply system 40 is received (step S1023).

When it is determined in the determination of step S1023 that the approval of the power sale is received, the power network management apparatus 20 confirms whether the corresponding power can be transmitted (step S1024).

Then, the power transaction management apparatus 10 determines whether the power transmission can be performed with respect to a confirmation result (step S1025).

In the determination in step S1025, when the power transmission cannot be performed, the power supply system 40 and the power demand system 50 for the corresponding power demand and supply are notified of the power transmission being impossible (step S1030).

In the determination in step S1025, when the power transmission can be performed, the power supply system 40 and the power demand system 50 for the corresponding power demand and supply are notified of contract establishment (step S1026).

Then, the power transaction management apparatus 10 deletes and updates the power sale report for which the contract is established (step S1027).

The power transaction management apparatus 10 notifies the power network management apparatus 20 of the contract (power transmission schedule information) of the corresponding power demand and supply (step S1028).

Then, the power transaction management apparatus 10 requests the distributed ledger system 30 to record the power demand and supply information for which the contract is established (step S1029).

When it is determined in the determination of step S1023 that the approval of the power sale is not received, the power transaction management apparatus 10 then determines whether the power sale being impossible is received (step S1031).

When it is determined in the determination of step S1031 that the power sale being impossible is received, the power sale being impossible is notified to the corresponding power demand system 50 (step S1032).

When it is determined in the determination of step S1031 that the power sale being impossible is not received, or when any of steps S1029, S1030, and S1032 is executed, the power transaction management apparatus 10 then determines whether a power sale desire (power supply desire) is received (FIG. 10C, step S1033).

When it is determined in the determination of step S1033 that the power sale desire (power supply desire) is received, and there is a corresponding power demand schedule, the designated power demand system 50 is notified (step S1034). When there is no corresponding power demand schedule, a reply indicating that the desire cannot be accepted is sent to the power supply system 40 that transmits the power sale desire.

When it is determined in the determination of step S1033 that the power sale desire is not received, or when step S1034 is executed, the power transaction management apparatus 10 then determines whether approval of a power purchase from the power demand system 50 is received (step S1035).

When it is determined in the determination of step S1035 that the approval of the power purchase is received, the power network management apparatus 20 confirms whether the corresponding power can be transmitted (step S1036).

The power transaction management apparatus 10 determines whether the power transmission can be performed with respect to a confirmation result (step S1037).

In the determination in step S1037, when the power transmission cannot be performed, the power demand system 50 and the power supply system 40 for the corresponding power demand and supply are notified of the power transmission being impossible (step S1042).

In the determination in step S1037, when the power transmission can be performed, the power demand system 50 and the power supply system 40 for the corresponding power demand and supply are notified of contract establishment (step S1038).

The power transaction management apparatus 10 deletes and updates a power purchase report for which the contract is established (step S1039).

The power transaction management apparatus 10 notifies the power network management apparatus 20 of the contract (power transmission schedule information) of the corresponding power demand and supply (step S1040).

The power transaction management apparatus 10 requests the distributed ledger system 30 to record the power demand and supply information for which the contract is established (step S1041).

When it is determined in the determination of step S1035 that the approval of the power purchase is not received, the power transaction management apparatus 10 then determines whether the power purchase being impossible is received (step S1043).

When it is determined in the determination of step S1043 that the power purchase being impossible is received, the power purchase being impossible is notified to the corresponding power supply system 40 (step S1044).

When it is determined in the determination of step S1043 that the power purchase being impossible is not received, or when any of steps S1041, S1042, and S1044 is executed, the power transaction management apparatus 10 determines whether it is an end time of the power transaction management (step S1045).

When it is determined in the determination of step S1045 that it is the end time of the power transaction management, the power transaction management is ended (step S1046).

When it is determined in the determination of step S1045 that it is not the end time of the power transaction management, the process returns to step S1011 and continues.

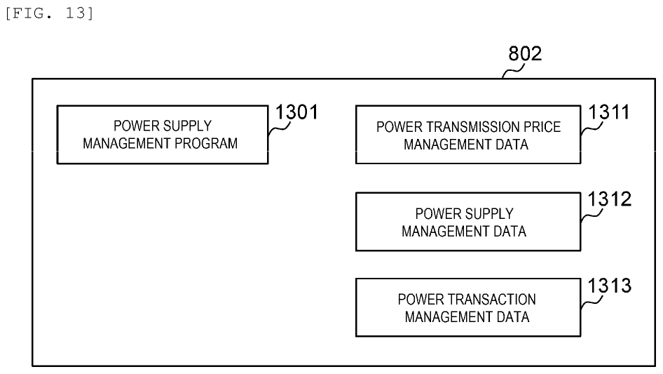

FIG. 11 is a diagram showing an example of data stored in a memory in the power network management apparatus 20 according to the first embodiment.

A power network management program 1101 is loaded into the main memory 802 and executed. In addition, power network management data 1111 and power transmission price management data 1112 necessary for executing the program are held. The power network management data 1111 is data shown in FIG. 2, and is data of a power transmission plan for each power transmission line. The power transmission price management data 1112 is data shown in (a) and (b) of FIG. 3, and includes the power transmission price, the utilization rate (congestion degree) data, and the like.

As described above, the power network management apparatus 20 has the same configuration as the functional block diagram of the power transaction management apparatus 10 shown in FIG. 8. Therefore, in the description of FIG. 11, data stored in the memory in the power network management apparatus 20 is shown using the main memory 802 of FIG. 8.

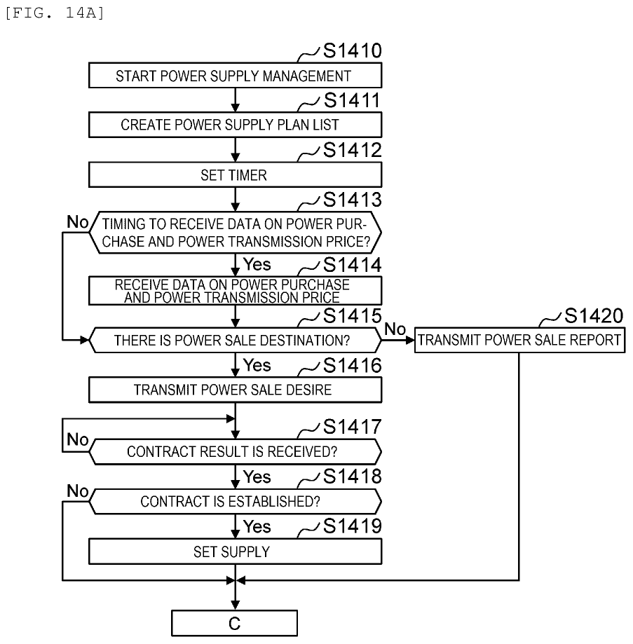

FIG. 12 is a flowchart showing a power network management procedure of the power network management apparatus 20 according to the first embodiment.

The CPU 801 of the power network management apparatus 20 loads the power network management program 1101 stored in the storage 803 into the main memory 802, and starts power network management (step S1210).

The power network management apparatus 20 periodically sets a timer for evaluating a state of a transmission network (step S1211). For example, the state of the transmission network is evaluated at 10-minute intervals.

The power network management apparatus 20 determines whether it is a timing to evaluate the power network (step S1212).

When it is determined in the determination in step S1212 that it is the timing to evaluate the power network, the timer is reset (step S1213).

The power network management apparatus 20 evaluates the utilization rate (congestion degree) of each power transmission line and sets the power transmission price (step S1214). For example, when the utilization rate is 50% or more, it is evaluated that the power transmission line is congested, and the power transmission price is set higher as compared with when the power transmission line is not congested.

Then, the power network management apparatus 20 notifies the power transaction management apparatus 10 of the set power transmission price management data ((a) or (b) of FIG. 3) (step S1215).

When it is determined in the determination of step S1212 that it is not the timing to evaluate the power network, or when step S1215 is executed, the power network management apparatus 20 determines whether an inquiry about whether power transmission can be performed is received from the power transaction management apparatus 10 (step S1216).

When it is determined in the determination in step S1216 that the inquiry about whether the power transmission can be performed is received, it is determined whether the power transmission for the power demand and supply which is being inquired can be performed (step S1217).

The power network management apparatus 20 replies a determination result to the power transaction management apparatus 10 (step S1218).

When it is determined in the determination of step S1216 that the inquiry about whether the power transmission can be performed is not received, or when step S1218 is executed, the power network management apparatus 20 then determines whether contract establishment of power demand and supply (power transmission schedule) is received (step S1219).

When it is determined in the determination in step S1219 that the contract establishment of the power demand and supply is received, the power network management data shown in FIG. 2 is updated, and a setting of the power transmission with respect to the switch 60 is executed (step S1220).

When it is determined in the determination of step S1219 that the contract establishment of the power demand and supply is not received, or when step S1220 is executed, the power network management apparatus 20 then determines whether it is an end time of the transmission network management (step S1221).

When it is determined in the determination of step S1221 that it is the end time of the transmission network management, the transmission network management is ended (step S1222).

When it is determined in the determination of step S1221 that it is not the end time of the transmission network management, the process returns to step S1212 and continues.

FIG. 13 is a diagram showing an example of data stored in a memory in a power supply management apparatus according to the first embodiment.

A power supply management program 1301 is loaded into the main memory 802 and executed. In addition, power transmission price management data 1311, power supply management data 1312, and power transaction management data 1313 necessary for executing the program are held. The power transmission price management data 1311 is data shown in (a) or (b) of FIG. 3, and includes the power transmission price, the utilization rate (congestion degree) data, and the like. The power supply management data 1312 is a plan of power supply scheduled by the power supply management apparatus itself, and is data shown in FIG. 4. The power transaction management data 1313 is data in which a contract of power demand and supply is established, and is data in which the power supply side data (FIG. 4) and the power demand side data (FIG. 5) are set.

The power supply management apparatus has the same configuration as the functional block diagram of the power transaction management apparatus 10 shown in FIG. 8. Therefore, in the description of FIG. 11, data stored in the memory in the power supply management apparatus is shown using the main memory 802 of FIG. 8.

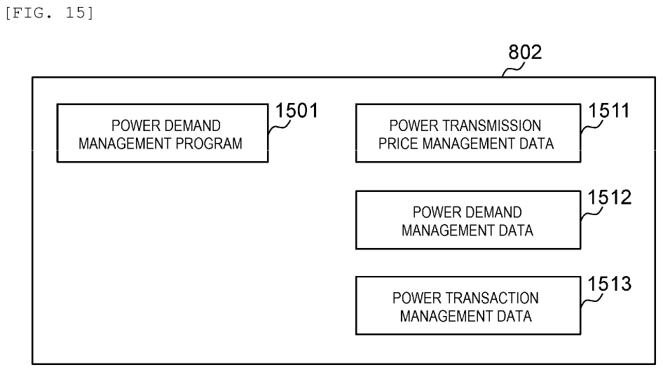

FIGS. 14A and 14B are a flowchart showing a power supply management procedure of the power supply management apparatus according to the first embodiment.

The CPU 801 of the power supply management apparatus loads the power supply management program 1301 stored in the storage 803 into the main memory 802, and starts power supply management (step S1410).

The power supply management apparatus creates a list of power supply plans for a future time, for example, on a next day, in consideration of weather states (step S1411).

Then, the power supply management apparatus sets a timer for timing control for receiving the power transmission price management data and the like (step S1412).

Thereafter, the power supply management apparatus determines whether it is a timing to request the power demand (power purchase) management data (data in FIG. 5) and the power transmission price management data (data in FIG. 3) (step S1413).

When it is determined in the determination of step S1413 that it is the timing to request the power demand (power purchase) management data and the power transmission price management data, the power demand (power purchase) management data and the power transmission price management data are received from the power transaction management apparatus 10 (step S1414).

When it is determined in the determination of step S1413 that it is not the timing to request the power demand (power purchase) management data and the power transmission price management data, or when step S1414 is executed, the power supply management apparatus then selects one of the power supply plans from the power supply plan list, and determines whether there is a power sale destination (demand destination) (step S1415).

When it is determined in the determination of step S1415 that there is a power sale destination (demand destination), the power transaction management apparatus 10 is notified of a power sale (power supply) desire for the power demand side (step S1416).

Thereafter, the power supply management apparatus determines whether a result of whether a contract of power demand and supply is established is received (step S1417).

When it is determined in the determination of step S1417 that the result of whether the contract of the power demand and supply is established is not received, step S1417 is continued.

When it is determined in the determination of step S1417 that the result of whether the contract of the power demand and supply is established is received, the power supply management apparatus then determines whether the contract of the power demand and supply is established (step S1418).

When it is determined in the determination of step S1418 that the contract of the power demand and supply is established, a setting of power supply is executed (step S1419).

When it is determined in the determination of step S1415 that there is no power sale destination (demand destination), a power supply desire (power sale report) is notified to the power transaction management apparatus (step S1420).

When it is determined in the determination of step S1418 that the contract of the power demand and supply is not established, or when any one of step S1419 and step S1420 is executed, the power supply management apparatus then determines whether a power purchase desire (power demand desire) is received (step S1421).

When it is determined in the determination of step S1421 that the power purchase desire (power demand desire) is received, it is evaluated whether the power purchase desire can be corresponded to a power demand received as the power demand desire (power sale destination evaluation) (step S1422).

Then, when there is no problem in the evaluation of the power sale destination, the power supply management apparatus notifies the power transaction management apparatus 10 of approval of the power sale (power supply) (step S1423).

Thereafter, the power supply management apparatus determines whether a result of whether a contract of the corresponding power demand and supply is established is received (step S1424).

When it is determined in the determination of step S1424 that the result of whether the contract of the corresponding power demand and supply is established is not received, step S1424 is continued.

When it is determined in the determination of step S1424 that the result of whether the contract of the corresponding power demand and supply is established is received, it is determined whether the contract of the power demand and supply is established (step S1425).

When it is determined in the determination of step S1425 that the contract of the corresponding power demand and supply is established, a setting of power supply is executed (step S1426).

When it is determined in the determination of step S1425 that the contract of the corresponding power demand and supply is not established, or when step S1426 is executed, or when it is determined in the determination of step S1421 that the power purchase desire (power demand desire) is not received, the power supply management apparatus then determines whether the contract is established for all the planned power supplies (step S1427).

When it is determined in the determination of step S1427 that the contract is established for all the planned power supplies, the power supply management is ended (step S1428).

When it is determined in the determination of step S1427 that the contract is not established for all the planned power supplies, the power supply management apparatus then determines whether all the power sale reports for the power supplies for which the contract is not established are set (step S1429).

When it is determined in the determination of step S1429 that all the power sale reports for the power supply for which the contract is not established are not set, the process returns to step S1413 to execute the process.

When it is determined in the determination of step S1429 that all the power sale reports for the power supplies for which the contract is not established are set, the power supply management apparatus then determines whether it is a timing to request the power demand (power purchase) management data and the power transmission price management data (step S1430).

In the determination of step S1430, when it is determined that it is the timing to request the power demand (power purchase) management data and the power transmission price management data, the power supply management apparatus then receives the power demand (power purchase) management data and the power transmission price management data from the power transaction management apparatus 10 (step S1431).

Thereafter, when a reported power sale report update is necessary, the power supply management apparatus updates the power sale report (step S1432). For example, when a higher price power sale is assumed, the power sale report is updated.

When it is determined in the determination of step S1430 that it is not the timing to request the power demand (power purchase) management data and the power transmission price management data, or when step S1432 is executed, the process returns to step S1421 to execute the process.

FIG. 15 is a diagram showing an example of data stored in a memory in a power demand management apparatus according to the first embodiment.

A power demand management program 1501 is loaded into the main memory 802 and executed. In addition, power transmission price management data 1511, power demand management data 1512, and power transaction management data 1513 necessary for executing the program are held. The power transmission price management data 1511 is data shown in (a) or (b) of FIG. 3, and includes the power transmission price, the utilization rate (congestion degree) data, and the like. The power demand management data 1512 is a plan of power demand scheduled by the power demand management apparatus itself, and is data shown in FIG. 5. The power transaction management data 1513 is data in which a contract of power demand and supply is established, and is data in which the power demand side data (FIG. 5) and the power supply side data (FIG. 4) are set.

The power demand management apparatus has the same configuration as the functional block diagram of the power transaction management apparatus 10 shown in FIG. 8. Therefore, in the description of FIG. 11, data stored in the memory in the power demand management apparatus is shown using the main memory 802 of FIG. 8.

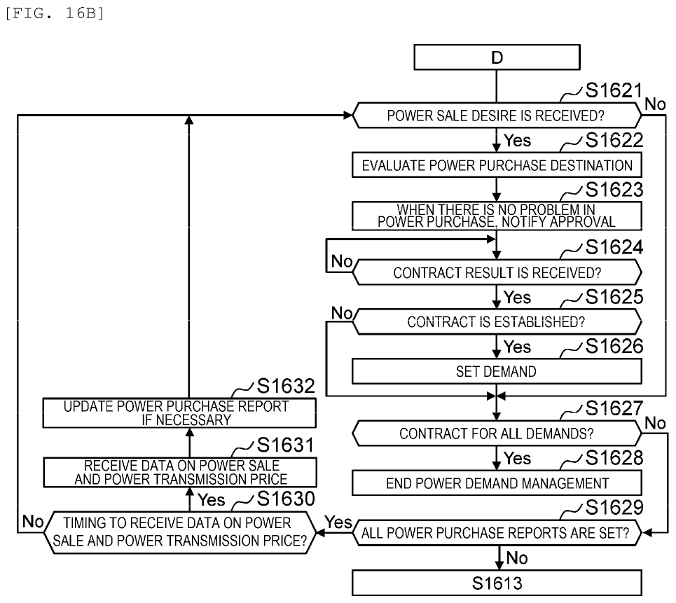

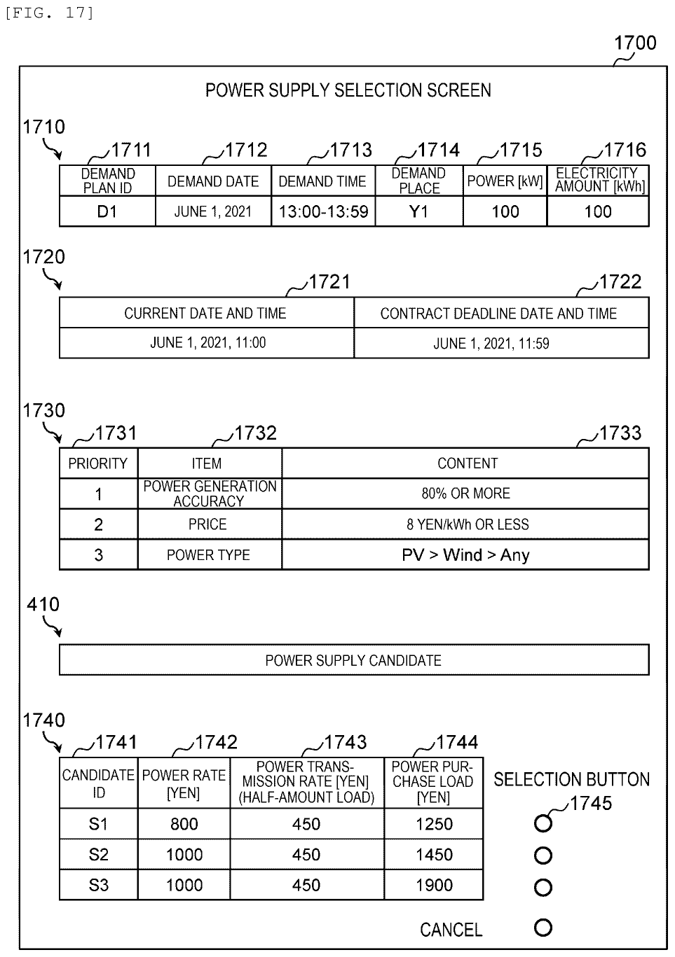

FIGS. 16A and 16B are a flowchart showing a power demand management procedure of the power demand management apparatus according to the first embodiment.

The CPU 801 of the power supply management apparatus loads the power demand management program 1501 stored in the storage 803 into the main memory 802, and starts power demand management (step S1610).

The power demand management apparatus creates a list of power demand plans for a future time, for example, on a next day, in consideration of a state of the power demand system (step S1611).

Then, the power demand management apparatus sets a timer for timing control for receiving the power transmission price management data and the like (step S1612).

Thereafter, the power demand management apparatus determines whether it is a timing to request the power supply (power sale) management data (data in FIG. 4) and the power transmission price management data (data in FIG. 3) (step S1613).

When it is determined in the determination of step S1613 that it is the timing to request the power supply (power sale) management data and the power transmission price management data, the power supply (power sale) management data and the power transmission price management data are received from the power transaction management apparatus 10 (step S1614).

When it is determined in the determination of step S613 that it is not the timing to request the power supply (power sale) management data and the power transmission price management data, or when step S1614 is executed, the power demand management apparatus then selects one of the power demand plans from the power demand plan list, and determines whether there is a power purchase destination (supply source) (step S1615).

When it is determined in the determination of step S1615 that there is a power purchase destination (supply source), the power transaction management apparatus 10 is notified of a power purchase (power demand) desire for the power supply side (step S1616).

Thereafter, the power demand management apparatus determines whether a result of whether a contract of power demand and supply is established is received (step S1617).

When it is determined in the determination of step S1617 that the result of whether the contract of the power demand and supply is established is not received, step S1617 is continued.

When it is determined in the determination of step S1617 that the result of whether the contract of the power demand and supply is established is received, the power demand management apparatus then determines whether the contract of the power demand and supply is established (step S1618).

When it is determined in the determination of step S1618 that the contract of the power demand and supply is established, a setting of power demand is executed (step S1619).

When it is determined in the determination of step S1615 that there is no power purchase destination (supply source), a power demand desire (power purchase report) is notified to the power transaction management apparatus (step S1620).

When it is determined in the determination of step S1618 that the contract of the power demand and supply is not established, or when any one of step S1619 and step S1620 is executed, the power demand management apparatus then determines whether a power sale desire (power supply desire) is received (step S1621).

When it is determined in the determination of step S1621 that the power sale desire (power supply desire) is received, it is evaluated whether the power sale desire can be corresponded to a power supply received as the power supply desire (power purchase destination evaluation) (step S1622).

Then, when there is no problem in the power purchase destination evaluation, the power demand management apparatus notifies the power transaction management apparatus 10 of approval of the power purchase (power demand) (step S1623).

Thereafter, the power supply management apparatus determines whether a result of whether a contract of the corresponding power demand and supply is established is received (step S1624).

When it is determined in the determination of step S1624 that the result of whether the contract of the corresponding power demand and supply is established is not received, step S1624 is continued.

When it is determined in the determination of step S1624 that the result of whether the contract of the corresponding power demand and supply is established is received, it is determined whether the contract of the power demand and supply is established (step S1625).

When it is determined in the determination of step S1625 that the contract of the corresponding power demand and supply is established, a setting of power demand is executed (step S1626).

When it is determined in the determination of step S1625 that the contract of the corresponding power demand and supply is not established, or when step S1626 is executed, or when it is determined in the determination of step S1621 that the power sale desire (power supply desire) is not received, the power demand management apparatus then determines whether the contract is established for all the planned power demands (step S1627).

When it is determined in the determination of step S1627 that the contract is established for all the planned power demands, the power demand management is ended (step S1628).

When it is determined in the determination of step S1627 that the contract is not established for all the planned power demands, the power demand management apparatus then determines whether all the power purchase reports for the power demands for which the contract is not established are set (step S1629).

When it is determined in the determination of step S1629 that all the power purchase reports for the power demand for which the contract is not established are not set, the process returns to step S1613 to execute the process.

When it is determined in the determination of step S1629 that all the power purchase reports for the power demands for which the contract is not established are set, the power demand management apparatus then determines whether it is a timing to request the power supply (power sale) management data and the power transmission price management data (step S1630).

When it is determined in the determination of step S1630 that it is the timing to request the power supply (power sale) management data and the power transmission price management data, the power demand management apparatus then receives the power supply (power sale) management data and the power transmission price management data from the power transaction management apparatus 10 (step S1631).

Thereafter, when a reported power purchase report update is necessary, the power demand management apparatus updates the power sale report (step S1632). For example, when a lower price power purchase is assumed, the power purchase report is updated.

When it is determined in the determination of step S1630 that it is not the timing to request the power supply (power sale) management data and the power transmission price management data, or when step S1632 is executed, the process returns to step S1621 to execute the process.

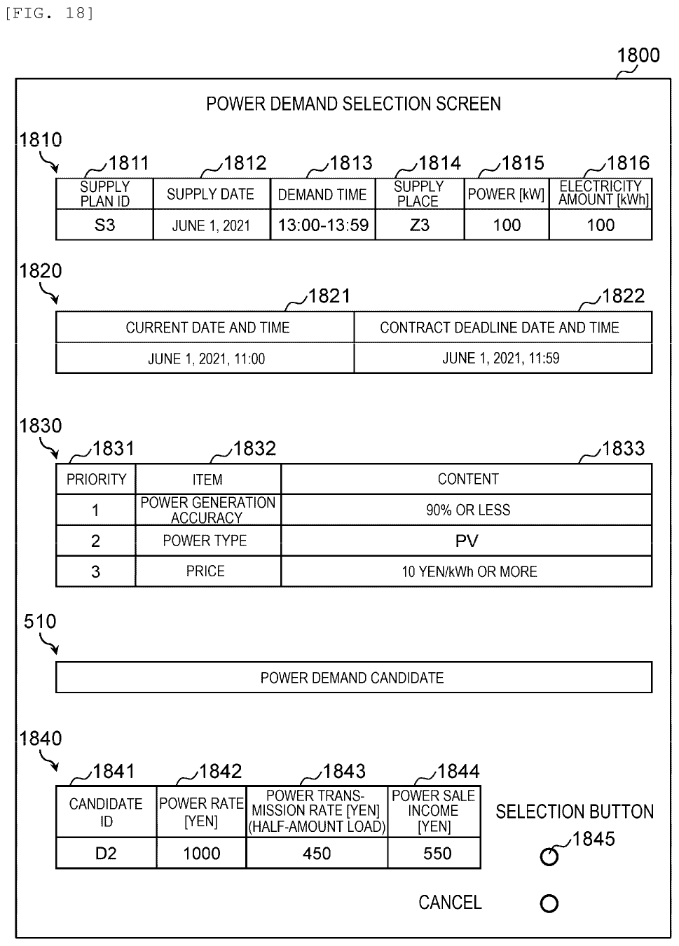

FIG. 17 is a diagram showing a power supply selection screen according to the first embodiment.

The power demand management apparatus selects a power supply source for power that is scheduled to be demanded. In the embodiment, the power demand management apparatus presents a power supply selection screen 1700 shown in FIG. 17 to an administrator of the power demand system 50. The power supply selection screen 1700 includes fields of a power demand plan 1710, a contract deadline 1720, a power supply selection priority 1730, a power supply candidate 410, and a power supply selection 1740.

In the embodiment, the power demand plan 1710 indicates that a demand plan ID 1711 is scheduled to be D1, a demand date 1712 is scheduled to be Jun. 1, 2021, a demand time 1713 is scheduled to be 13:00 to 13:59, a demand place 1714 is scheduled to be Y1, a demanded power 1715 is scheduled to be 100 kW, and an electricity amount 1716 is scheduled to be 100 kWh. In addition, the contract deadline 1720 for a power demand indicates that a current date and time 1721 is Jun. 1, 2021, 11:00, and a contract deadline date and time 1722 is Jun. 1, 2021, 11:59. In the embodiment, the contract of the power supply can be made up to one hour before a power demand start time, the contract of the power supply can be made at other times, such as up to 30 minutes before the power demand start time.

The power supply selection priority 1730 includes fields of a priority 1731, an information item 1732, and a content 1733 for the item. A priority 1 indicates that the power generation accuracy is designated and a value thereof is 80%. The same is applied to a priority 2 and a priority 3, items and contents corresponding thereto are presented. These priorities are registered in advance in the power demand management apparatus by the administrator of the power demand system 50.

In a field of the power supply candidate 410, the data shown in FIG. 4 is presented. The power supply selection 1740 includes fields of a power supply candidate ID 1741, a power rate 1742, a half-amount load 1743 of the power transmission rate, a power purchase load 1744 which is a sum of the power rate and the power transmission rate, and a selection button 1745. The candidate ID 1741 is a management ID indicated in the data of the power supply candidate 410.

In the embodiment, when the candidate ID is S1, it is indicated that the power rate is 800 yen, the power transmission rate (half-amount load) is 450 yen, and the power purchase load is 1250 yen. The same is applied to candidate IDs S2 and S3, the power rate, the power transmission rate (half-amount load), and the power purchase load are presented. The administrator of the power demand system 50 selects the power supply source from the power supply selection screen 1700. In the embodiment, the administrator of the power demand system 50 performs the selection, but the power demand management apparatus may automatically select the power supply source according to the priority 1730 of the power supply selection.

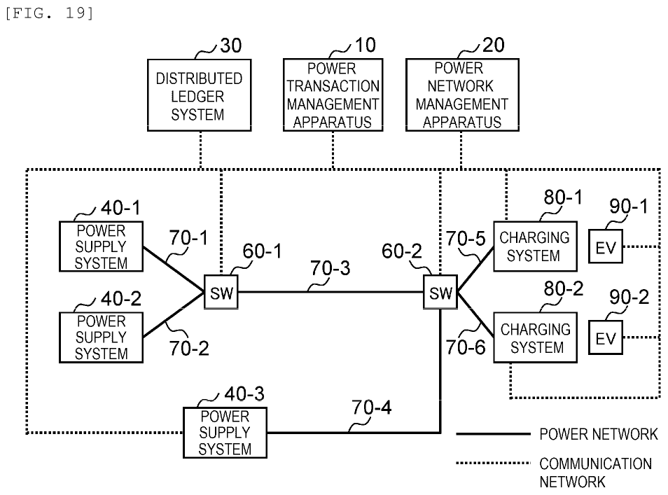

FIG. 18 is a diagram showing a power demand selection screen according to the first embodiment.

The power supply management apparatus selects a power demand destination for a power that is scheduled to be supplied. In the embodiment, the power supply management apparatus presents a power demand selection screen 1800 shown in FIG. 18 to an administrator of the power supply system 40. The power demand selection screen 1800 includes fields of a power supply plan 1810, a contract deadline 1820, a power demand selection priority 1830, a power demand candidate 510, and a power demand selection 1840.

In the embodiment, the power demand plan 1810 indicates that a supply plan ID 1811 is scheduled to be S3, a supply date 1812 is scheduled to be Jun. 1, 2021, a supply time 1813 is scheduled to be 13:00 to 13:59, a supply place 1814 is scheduled to be Z3, a supplied power 1815 is scheduled to be 100 kW, and an electricity amount 1816 is scheduled to be 100 kWh. In addition, the contract deadline 1820 for a power supply indicates that a current date and time 1821 is Jun. 1, 2021, 11:00, and a contract deadline date and time 1822 is Jun. 1, 2021, 11:59. In the embodiment, the contract of the power demand can be made up to one hour before a power supply start time, the contract of the power demand can be made at other times, such as up to 30 minutes before the power supply start time.

The power demand selection priority 1830 includes fields of a priority 1831, an information item 1832, and a content 1833 for the item. A priority 1 indicates that the power generation accuracy is designated and a value thereof is 90% or less. In a priority 2, Photo Voltaic (PV) solar power generation is designated as a power generation type. In addition, a priority 3 indicates that 10 yen/kWh or more is designated as a demand price. These priorities are registered in advance in the power supply management apparatus by the administrator of the power supply system 40.

In a field of the power demand candidate 510, the data shown in FIG. 5 is presented. The power demand selection 1840 includes fields of a power supply candidate ID 1841, a power rate 1842 as a power sale, a half-amount load 1843 of the power transmission rate, a power sale income 1844 obtained by the power sale, and a selection button 1845. The candidate ID 1841 is a management ID indicated in the data of the power demand candidate 510.

In the embodiment, when the candidate ID is D2, it is indicated that the power rate is 1000 yen, the half-amount load of the power transmission rate is 450 yen, and the income obtained by the power sale is 550 yen. The administrator of the power supply system 40 selects the power demand destination from the power demand selection screen 1800. In the embodiment, the administrator of the power supply system 40 performs the selection, but the power supply management apparatus may automatically select the power demand destination according to the priority 1830 of the power demand selection.

As described above, in the embodiment, the power demand side receives the power transmission price based on the power supply report list and the power demand position, can autonomously select the power supply source, and does not inquire the possibility of supply to all of the other power supply sides, and thus it becomes possible to reduce a communication amount required for transaction contracts. In addition, the power supply side receives the power transmission price based on the power demand report list and the power supply position, can autonomously select the power demand destination, and does not inquire the possibility of demand to all of the other power demand sides, and thus it becomes possible to reduce the communication amount required for transaction contracts. A transmission network management side can set the power transmission price based on the utilization rate (congestion degree) of the transmission network. In the power transaction system as a whole, it is possible to perform a power transaction based on various indices such as the power price, the power transmission price according to a positional relationship of power demand and supply, the power generation type, and the power generation accuracy.

### Second Embodiment

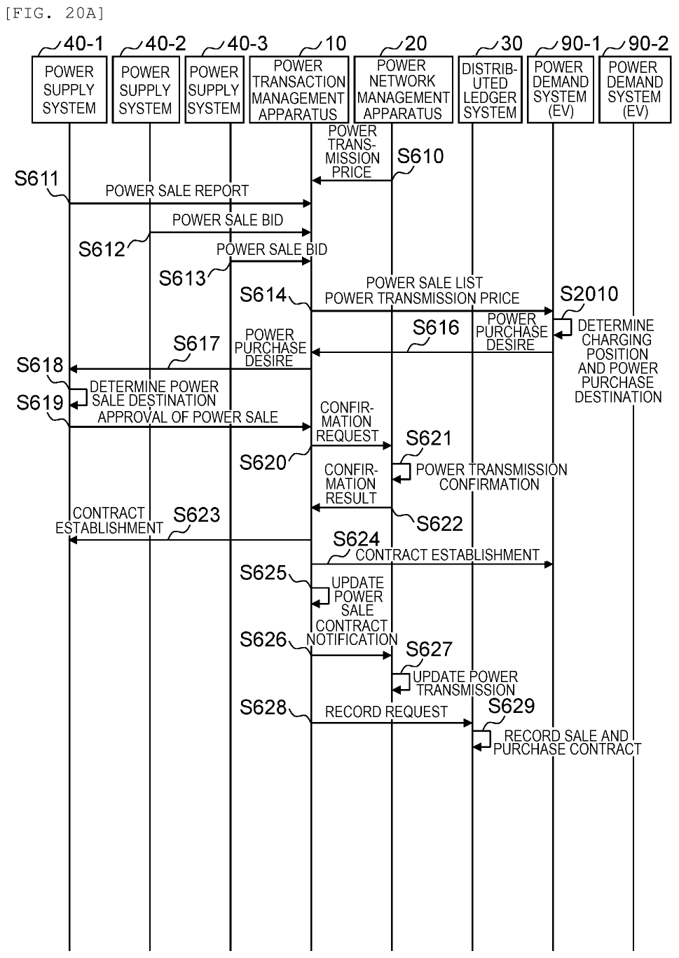

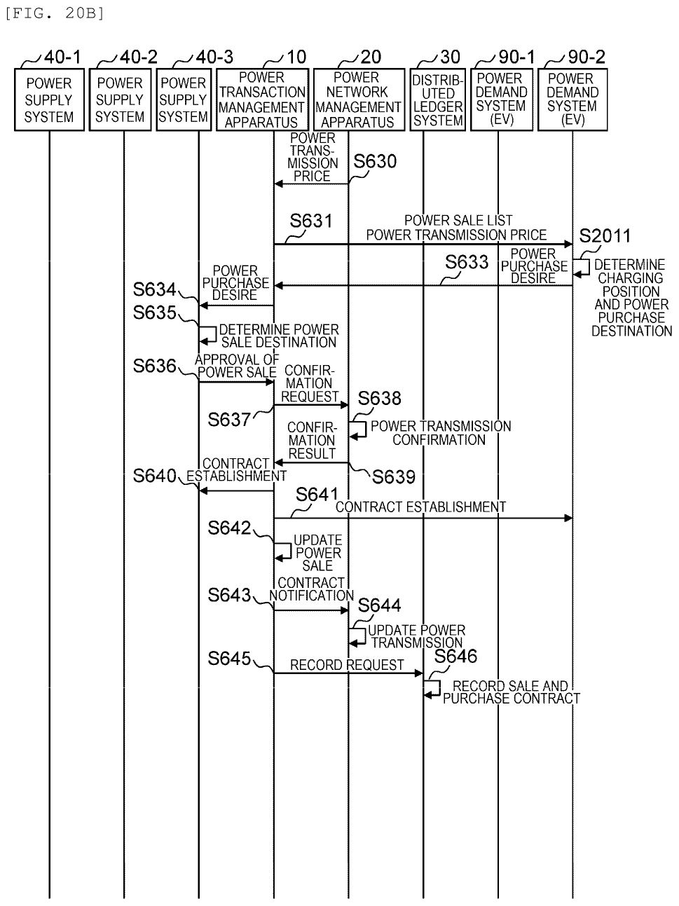

In the embodiment, a mobile power demand system is included, and an operation that can dynamically select a power demand position will be described. Hereinafter, a power transaction management operation according to the second embodiment will be described with reference to FIGS. 19, 20A, and 20B.

FIG. 19 is a functional block diagram showing a configuration of a power transaction system according to the second embodiment.

A power transaction system according to the embodiment is a mobile power demand system instead of the power demand system 50, and includes a configuration in which charging systems 80-1 and 80-2 are connected to the switch 60-2, and Electric Vehicles (EVs) 90-1 and 90-2 can be charged by either of the charging systems 80-1 and 80-2. When the individual charging systems are not distinguished from the charging systems 80-1 and 80-2, the charging systems are collectively referred to as a charging system 80 in the following description. In addition, when the individual EVs are not distinguished from the EVs 90-1 and 90-2, the EVs are collectively referred to as an EV 90 in the following description.

When a report of a power demand is registered in the power transaction management apparatus 10 by the power demand system (EV) 90, the power supply system 40 selects a power demand destination from the report. On the other hand, when the report of the power demand is not registered in the power transaction management apparatus 10 or when an appropriate demand destination is not registered, the power supply system 40 registers a report of a power supply in the power transaction management apparatus 10.

When a report of a power supply is registered in the power transaction management apparatus 10, the power demand system (EV) 90 selects a power supply source from the report. On the other hand, when the report of the power supply is not registered in the power transaction management apparatus 10 or when an appropriate supply source is not registered, the power demand system (EV) 90 registers a report of a power demand in the power transaction management apparatus 10.

The power network management apparatus 20 evaluates a state (congestion degree) of the power network at predetermined time intervals, dynamically sets the power transmission price, and notifies the power transaction management apparatus 10 of the power transmission price. The congestion degree of the power network is a utilization rate for an allowable power transmission amount on a power line, and for example, it is determined that the power transmission line is congested when the utilization rate is 50% or more. In addition, an inquiry about whether the power can be transmitted from the power transaction management apparatus is determined and responded.

The power transaction management apparatus 10 receives and registers power transmission price data from the power network management apparatus 20, the power supply report from the power supply system 40, and the power demand report from the power demand system (EV) 90. In addition, when report data of the power demand from the power supply system 40 and the power transmission price data are requested, the power transaction management apparatus 10 provides the report data of the power demand plan from the power supply system 40 and the power transmission price data. When report data of the power supply from the power demand system (EV) 90 and the power transmission price data are requested, the power transaction management apparatus 10 provides the report data of the power supply from the power demand system (EV) 90 and the power transmission price data. The power transaction management apparatus 10 confirms with the power network management apparatus 20 whether power as a power transaction candidate can be transmitted based on a request from the power supply system 40 or the power demand system (EV) 90. When there is no problem in the power transmission, a contract of the corresponding power transaction is established and recorded in the distributed ledger system 30.

FIG. 20A is a sequence diagram showing a power transaction when there is a power supply candidate (power sale and purchase transaction performed by the EV first time) according to the second embodiment.

The power transaction sequence of FIG. 20A is a sequence diagram of an operation in which the power demand system 50 is replaced with the power demand system (EV) 90 with respect to the power transaction sequence of FIG. 6A. Therefore, the basic operation is the same as that of the first embodiment, and the same reference numerals are given to the same operations. The second embodiment is different from the first embodiment in an operation of step S2010. In step S2010, when the power demand system (EV) 90-1 receives the power sale list and the power transmission price data, the power demand system (EV) 90-1 selects a power supply source from the power sale list and the power transmission price data, at this time, one of the charging systems 80-1 and 80-2 is selected as a power demand point, the power demand point is determined, and the power transaction management apparatus 10 is notified of the power purchase desire for selecting the power supply source.

FIG. 20B is a sequence diagram showing a power transaction when there is a power supply candidate (power sale and purchase transaction performed by the EV second time) according to the second embodiment.

The power transaction sequence of FIG. 20B is a sequence diagram of an operation in which the power demand system 50 is replaced with the power demand system (EV) 90 with respect to the power transaction sequence of FIG. 6B. Therefore, the basic operation is the same as that of the first embodiment, and the same reference numerals are given to the same operations. An operation different from that of the first embodiment is an operation of step S2011. In step S2011, when the power demand system (EV) 90-2 receives the power sale list and the power transmission price data, the power demand system (EV) 90-2 selects a power supply source from the power sale list and the power transmission price data, at this time, one of the charging systems 80-1 and 80-2 is selected as the power demand point, the power demand point is determined, and the power transaction management apparatus 10 is notified of the power purchase desire for selecting the power supply source.

As described above, according to the invention, the power transmission price is dynamically set in accordance with the state of the power network, and a power consumer side is provided with a means capable of autonomously selecting the power supply destination based on evaluation indices such as the power generation accuracy, the power rate, and the power transmission rate from a power supply report list and the power transmission price based on a demand position, so that a system in which a power consumer side can autonomously select a power supplier based on various indices can be provided. In addition, since the power consumer side also presents the power demand plan, it is possible for the supplier to autonomously make a contract.

Specifically, for example, it is possible to provide a system in which a power consumer can select a power generation company that mainly performs a power transaction by renewable energy with different power generation sources such as solar power generation and wind power generation, and it is possible to contribute to environmentally friendly business. In addition, the movable power demand side receives the power transmission price based on the power supply report list and the power demand position, and can autonomously select the power demand position and the power supply source. As an effect, the communication amount is reduced, and the power consumer side can autonomously select the power supplier.

According to the first and second embodiments of the invention described above, the following effects are obtained.

(1) A power transaction system that performs demand and supply transactions of a power includes one or more power supply systems 40 configured to manage supplies of the power, one or more power demand systems 50 configured to manage demands of the power, and a power transaction management apparatus 10 configured to manage demand and supply transactions of the power. The one or more power supply systems 40 each register a power supply plan having a plurality of conditions in the power transaction management apparatus 10, and the power demand system 50 acquires the power supply plan registered by each of the power supply systems 40 from the power transaction management apparatus 10 and selects the power supply system 40 as a desired power supply source based on the acquired power supply plan, thereby establishing the demand and supply transactions. In this manner, in the power transaction, the power supply source can be autonomously selected from the power consumer side.

(2) The one or more power demand systems 50 each register a power demand plan having a plurality of conditions in the power transaction management apparatus 10, and the power supply system 40 acquires the power demand plan registered in each of the power demand systems 50 from the power transaction management apparatus 10 and selects the power demand system 50 as a desired power demand destination based on the acquired power demand plan, thereby establishing the demand and supply transactions. In this manner, the power demand destination can be autonomously selected from the power supplier side.

(3) The power transaction system further includes a power network management apparatus 20 configured to manage a power network that transmits power, the power network management apparatus 20 creates power transmission price data for each power transmission region based on a state of the power transmission region and registers the power transmission price data in the power transaction management apparatus 10, and the power demand system 50 acquires the power supply plan and the power transmission price data from the power transaction management apparatus 10 and selects the power supply system 40 based on the power supply plan and the power transmission price data, thereby establishing demand and supply transactions. In this manner, the power network management apparatus 20 sets a power transmission price and a power demand system 50 side selects the power supply source, so that it is possible to select a power supply source that reduces a communication congestion degree in the power transaction.

(4) The power transaction system further includes a power network management apparatus configured to manage a power network that transmits power, the power network management apparatus 20 creates power transmission price data for each power transmission region based on a state of the power transmission region and registers the power transmission price data in the power transaction management apparatus 10, and the power supply system 40 selects a desired power demand system 50 based on the power demand plan and the power transmission price data, thereby establishing demand and supply transactions. In this manner, the power network management apparatus 20 sets a power transmission price and a power supply system 40 side selects the power demand destination, so that it is possible to select a power demand destination that reduces a communication congestion degree in the power transaction.

(5) The power transaction system includes a power generation accuracy in the plurality of conditions of the power supply plan. In this manner, the power supply plan including an implementation probability of power generation can be registered in the power transaction management apparatus 10.

(6) The power transaction system includes a power generation accuracy in the plurality of conditions of the power demand plan. In this manner, the power demand plan including an implementation probability of power generation can be registered in the power transaction management apparatus 10.

(7) The power transaction system further includes a distributed ledger system 30, and the established demand and supply transactions are recorded in the distributed ledger system 30. In this manner, a transaction history of the demand and supply transactions can be recorded.

(8) In power supply transaction management, a method of establishing a power supply transaction is implemented by a computer acquiring one or more power supply plans from the power transaction management apparatus 10, and selecting the power supply system 40 as a desired power supply source based on a power demand position. By implementing such a method, a consumer can autonomously select a desired supply source from power supplies having a plurality of attributes.

(9) In power supply transaction management, a method of establishing a demand transaction is implemented by further acquiring the power transmission price data for each power transmission region from the power network management apparatus 20, and selecting the power supply system 40 as a desired power supply source based on the power supply plan, the power demand position, and the power transmission price data. By performing such a method, a desired supply source can be selected based on the power transmission price and the power supplies having a plurality of attributes.

(10) In the power supply transaction management, when there is no power supply system 40 for which a power supply transaction is desired, a method of the power demand system 50 registering a power demand plan having a plurality of attributes in the power transaction management apparatus is implemented. By implementing such a method, the power transaction management apparatus 10 can enter a state in which the power supply plan and the power demand plan are registered.

(11) In the power supply transaction management, when a power supply desire is received from the power supply system, a method of selecting the power supply system 40 as a power supply source based on a power demand position and power transmission price data is implemented. By implementing such a method, the power transaction management apparatus 10 can select the power supply source based on the power supply desire considering the state of the power transmission network.

(12) In power demand transaction management, a method of establishing a power demand transaction is implemented by a computer acquiring one or more power demand plans from the power transaction management apparatus 10, and selecting the power demand system 50 as a desired power demand destination based on a power supply position. By implementing such a method, a supplier can autonomously select a desired demand destination from power demands having a plurality of attributes.

(13) In power demand transaction management, a method of establishing a power supply transaction is implemented by further acquiring the power transmission price data for each power transmission region from the power network management apparatus 20, and selecting the power demand system 50 as a desired power demand destination based on the power demand plan, the power supply position, and the power transmission price data. By implementing such a method, a desired demand destination can be selected based on the power transmission price and the power demands having a plurality of attributes.

(14) In the power demand transaction management, when there is no power demand system 50 for which a power demand transaction is desired, a method of the power supply system 40 registering a power supply plan having a plurality of attributes in the power transaction management apparatus 10 is implemented. By implementing such a method, the power transaction management apparatus 10 can enter a state in which the power supply plan and the power demand plan are registered.

(15) In the power demand transaction management, when a power demand desire is received from the power demand system 50, a method of selecting the power demand system 50 as a power demand destination based on a power demand position and power transmission price data is implemented. By implementing method, the power transaction management apparatus 10 can select the power demand destination based on the power demand desire considering the state of the power transmission network.

The invention is not limited to the embodiments described above, and various modifications and other configurations can be combined without departing from the gist of the invention. Further, the invention is not limited to the invention including all configurations described in the above embodiments, and includes a configuration in which a part of the configurations is deleted.

### REFERENCE SIGNS LIST

10 power transaction management apparatus
20 power network management apparatus
30 distributed ledger system
40-1 to 40-3 power supply system
50-1, 50-2 power demand system
60-1, 60-2 switch
80-1, 80-2 charging system
90-1, 90-2 EV

1. A power transaction system that performs demand and supply transactions of a power comprising:
one or more power supply systems configured to manage supplies of the power;
one or more power demand systems configured to manage demands of the power; and
a power transaction management apparatus configured to manage demand and supply transactions of the power, wherein
the one or more power supply systems each register a power supply plan having a plurality of conditions in the power transaction management apparatus, and
the power demand system acquires the power supply plan registered by each of the power supply systems from the power transaction management apparatus and selects the power supply system as a desired power supply source based on the acquired power supply plan, thereby establishing the demand and supply transactions.

2. The power transaction system according to claim 1, wherein
the one or more power demand systems each register a power demand plan having a plurality of conditions in the power transaction management apparatus, and
the power supply system acquires the power demand plan registered by each of the power demand systems from the power transaction management apparatus and selects the power demand system as a desired power demand destination based on the acquired power demand plan, thereby establishing the demand and supply transactions.

3. The power transaction system according to claim 1, further comprising:
a power network management apparatus configured to manage a power network that transmits the power, wherein
the power network management apparatus creates power transmission price data for each power transmission region based on a state of the power transmission region and registers the power transmission price data in the power transaction management apparatus, and
the power demand system acquires the power supply plan and the power transmission price data from the power transaction management apparatus and selects the power supply system based on the power supply plan and the power transmission price data, thereby establishing the demand and supply transactions.

4. The power transaction system according to claim 2, further comprising:
a power network management apparatus configured to manage a power network that transmits the power, wherein
the power network management apparatus creates power transmission price data for each power transmission region based on a state of the power transmission region and registers the power transmission price data in the power transaction management apparatus, and
the power supply system acquires the power demand plan and the power transmission price data from the power transaction management apparatus and selects the power demand system based on the power demand plan and the power transmission price data, thereby establishing the demand and supply transactions.

5. The power transaction system according to claim 3, wherein
a power generation accuracy is included in the plurality of conditions of the power supply plan.

6. The power transaction system according to claim 4, wherein
a power generation accuracy is included in the plurality of conditions of the power demand plan.

7. The power transaction system according to claim 5, further comprising:
a distributed ledger system, wherein
the established demand and supply transactions are recorded in the distributed ledger system.

8. A power supply transaction management method comprising:
establishing a power supply transaction by a computer acquiring one or more power supply plans from a power transaction management apparatus, and selecting a power supply system as a desired power supply source based on a power demand position.

9. The power supply transaction management method according to claim 8, wherein
the power supply transaction is established by further acquiring power transmission price data for each power transmission region from a power network management apparatus, and selecting the power supply system as the desired power supply source based on the power supply plan, the power demand position, and the power transmission price data.

10. The power supply transaction management method according to claim 9, wherein
when there is no power supply system for which the power supply transaction is desired, a power demand system registers a power demand plan having a plurality of attributes in the power transaction management apparatus.

11. The power supply transaction management method according to claim 10, wherein
when a power supply desire is received from the power supply system, the power supply system is selected as the power supply source based on the power demand position and the power transmission price data.

12. A power demand transaction management method comprising:
establishing a power demand transaction by a computer acquiring one or more power demand plans from a power transaction management apparatus, and selecting a power demand system as a desired power demand destination based on a power supply position.

13. The power demand transaction management method according to claim 12, wherein
the power demand transaction is established by further acquiring power transmission price data for each power transmission region from a power network management apparatus, and selecting the power demand system as the desired power demand destination based on the power demand plan, the power supply position, and the power transmission price data.

14. The power demand transaction management method according to claim 13, wherein
when there is no power demand system for which the power demand transaction is desired, a power supply system registers a power supply plan having a plurality of attributes in the power transaction management apparatus.

15. The power demand transaction management method according to claim 14, wherein
when a power demand desire is received from the power demand system, the power demand system is selected as the power demand destination based on the power supply position and the power transmission price data.
